(19) United States
(12) Patent Application Publication
(10) Pub. No.: US 2010/0020163 A1
(43) Pub. Date: Jan. 28, 2010

(54) FLUORESCENCE ENDOSCOPE

(75) Inventors: Toshiaki Watanabe, Tokyo (JP); Atsushi Okawa, Tokyo (JP); Yasushige Ishihara, Tokyo (JP); Ryo Karasawa, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: OLYMPUS CORPORATION, Tokyo (JP)

(21) Appl. No.: 12/518,377

(22) PCT Filed: Dec. 7, 2007
(86) PCT No.: PCT/JP2007/073712

§ 371 Date: Jun. 9, 2009

(30) Foreign Application Priority Data
Dec. 11, 2006 (JP) 2006-333688

(51) Int. Cl. H04N 7/18

(52) U.S. Cl. 348/68; 348/E07.085

(57) ABSTRACT

A fluorescence endoscope is provided that can easily judge whether body-cavity tissue is benign or malignant when fluorescence generated at the entire inner circumferential face of the body cavity serving as a subject is observed. The fluorescence endoscope includes: an insertion portion (5) be inserted into a body cavity (3); a balloon (15) brought into contact with an inner wall of the body cavity (3) located in radial directions of the insertion portion (5), thereby positioning the insertion portion (5) with respect to the body cavity (3) in the radial directions of the insertion portion (5); a light emitting and introducing unit (17, 19) emits excitation light for irradiating the inner wall, outward in the radial directions of the insertion portion (5), and introduces fluorescence generated at the inner wall to the inside of the insertion portion (5) from a plurality of different radial directions of the insertion portion (5); an image-acquisition unit (21) acquires an image with the fluorescence introduced by the light emitting and introducing unit (17, 19); a correction-signal calculating unit (57) calculates a correction signal for correcting an image-acquisition signal output from the image-acquisition unit (21), based on a distance between the insertion portion (5) and a contact surface of the balloon (15) that is brought into contact with the inner wall; and a signal processing unit (57) corrects the intensity of the image-acquisition signal based on the correction signal and generates an image signal from the corrected image-acquisition signal.

### TECHNICAL FIELD

The present invention relates to fluorescence endoscopes.

### BACKGROUND ART

In recent years, technologies for diagnosing the state of a disease, such as cancer, in body tissue by using a medicinal agent that is accumulated in an area affected by the disease, such as cancer, and that generates fluorescence with excitation light have been developed. In particular, technologies are known in which a fluorescence endoscope or the like emits excitation light to irradiate a body in which the medicinal agent is injected; the fluorescence endoscope or the like detects fluorescence generated at the medicinal agent accumulated in a diseased area, in the form of a two-dimensional image; and the diseased area is diagnosed from the detected fluorescence intensity.

However, since the detected fluorescence intensity is inversely proportional to the square of the distance between a detecting unit and the diseased area, it is difficult to diagnose the diseased area from the detected fluorescence intensity unless the distance is maintained constant. Also in other methods of diagnosing a diseased area by using an endoscope, maintaining the distance between the diseased area and the detecting unit or the like at a predetermined distance is important to make a correct diagnosis. Therefore, various technologies for maintaining, in an endoscope, a constant distance between the diseased area and the detecting unit or the like have been proposed.

A technology for examination is known in which, in order to examine vascular tissue in a vascular lumen, a probe is inserted into the vascular lumen to irradiate the vascular tissue with illumination light emitted by the probe (see Patent Document 1, for example).

In this technology, a balloon is provided at the tip of the probe. For the above-mentioned examination, the balloon is inflated to be in contact with the vessel wall.

Further, in an endoscope for diagnosis using fluorescence, a technology is also known in which a lesion is diagnosed by using distance measurement means that generates a distance signal corresponding to the distance between an excitation-light irradiating unit and a subject and characteristic-value calculation means that corrects a fluorescence signal and a fluorescence image signal based on the distance signal (see Patent Document 2, for example).

According to this technology, with the distance measurement means and the characteristic-value calculation means, it is possible to diagnose a lesion without being affected by the distance between the irradiating unit and the subject.

Patent Document 1:

Japanese Unexamined Patent Application, Publication No.

Patent Document 2:

Japanese Unexamined Patent Application, Publication No.

### DISCLOSURE OF INVENTION

When a side-view endoscope is inserted into a lumen to observe fluorescence at the entire circumferential surface of the lumen or in a plurality of directions thereof, if the observation distance between the subject and the endoscope is changed, the level of fluorescence obtained by the endoscope strongly varies. Therefore, it is difficult to make a diagnosis of a lesion by using the fluorescence intensity.

Since the inner diameter of the lumen is not constant, the inner diameter of the lumen changes when the observation location is changed. Thus, it is difficult to maintain a constant distance between the surface of the lumen and a detecting unit of the endoscope.

The present invention has been made to solve the above-mentioned problems, and an object thereof is to provide a fluorescence endoscope that easily judges, when the side-view endoscope is used to observe fluorescence at the inner circumference of a body cavity serving as a subject in a plurality of directions, whether body cavity tissue in an observation area is benign tissue or malignant tissue, even if the observation distance between an insertion portion and the entire face of the inner circumference of the body cavity serving as the subject is changed.

In order to attain the above-mentioned object, the present invention provides the following solutions.

The present invention provides a fluorescence endoscope including: an insertion portion that is to be inserted into a body cavity; a balloon that is brought into contact with an inner wall of the body cavity located in radial directions of the insertion portion, thereby positioning the insertion portion with respect to the body cavity in the radial directions of the insertion portion; a light emitting and introducing unit that emits excitation light for irradiating the inner wall, outward in the radial directions of the insertion portion, and that introduces fluorescence generated at the inner wall to the inside of the insertion portion from a plurality of different radial directions of the insertion portion; an image-acquisition unit that acquires an image with the fluorescence introduced by the light emitting and introducing unit; a correction-signal calculating unit that calculates a correction signal for correcting an image-acquisition signal output from the image-acquisition unit, based on a distance between the insertion portion and a contact surface of the balloon that is brought into contact with the inner wall; and a signal processing unit that corrects the intensity of the image-acquisition signal based on the correction signal and generates an image signal from the corrected image-acquisition signal.

According to the present invention, the balloon is brought into contact with the inner wall of the body cavity located in the radial directions of the insertion portion, thereby positioning the insertion portion approximately at the center of the body cavity. In other words, the balloon can equalize the distances between the insertion portion and all partial areas on the inner wall of the body cavity in the radial directions of the insertion portion. The light emitting and introducing unit emits excitation light outward in the radial directions of the insertion portion to irradiate the inner wall of the body cavity whose distances from the insertion portion are equalized by the balloon. Therefore, the inner wall irradiated with the excitation light generates fluorescence. The fluorescence generated at the inner wall of the body cavity enters the insertion portion via the light emitting and introducing unit. If fluorescence is generated at a plurality of places on the inner wall of the body cavity, the fluorescence enters the insertion portion from a plurality of different radial directions of the insertion portion. Then, the image-acquisition unit acquires an image with the fluorescence entering the insertion portion via the light emitting and introducing unit.

The correction-signal calculating unit calculates a correction signal for correcting an image-acquisition signal output from the image-acquisition unit, based on the distance between the insertion portion and the contact surface of the balloon that is brought into contact with the inner wall. In other words, in response to a change in the distance between the insertion portion and the contact surface of the balloon that is brought into contact with the inner wall, the correction-signal calculating unit calculates a different correction signal. Then, the signal processing unit corrects the intensity of the image-acquisition signal output from the image-acquisition unit based on the correction signal calculated by the correction-signal calculating unit and generates an image signal from the corrected image-acquisition signal.

In this way, it is possible to generate the same image signal as that generated when a predetermined distance is maintained between the contact surface and the insertion portion. With the use of this image signal, even if the distance between the contact surface and the insertion portion is changed, it is possible to obtain the same fluorescence image as that obtained when the inner wall of the body cavity is observed always at the predetermined distance. Therefore, it can be easily judged whether body cavity tissue is benign tissue or malignant tissue.

The above-described invention may have a structure in which: the light emitting and introducing unit includes: an irradiation unit that emits the excitation light outward in the radial directions of the insertion portion; and a reflecting unit that reflects the fluorescence generated at the inner wall in the direction of the central axis of the insertion portion and that is disposed so as to be rotatable about the central axis; and the image-acquisition unit acquires the image with the fluorescence reflected by the reflecting unit.

Thus, excitation light is emitted outward in the radial directions of the insertion portion by the irradiation unit provided in the light emitting and introducing unit to irradiate the inner wall of the body cavity. The inner wall of the body cavity irradiated with the excitation light generates fluorescence. The fluorescence enters the insertion portion. The fluorescence entering the insertion portion is reflected in the direction of the central axis of the insertion portion by the reflecting unit provided in the light emitting and introducing unit. Since the reflecting unit is disposed so as to be rotatable about the central axis, the fluorescence generated at the inner wall of the body cavity located in a plurality of different radial directions of the insertion portion is reflected in the direction of the central axis of the insertion portion. The image-acquisition unit acquires an image with the fluorescence reflected by the reflecting unit. Therefore, according to the present invention, it is possible to obtain an image with the fluorescence generated at the inner wall of the body cavity located in the plurality of different radial directions of the insertion portion.

Note that the reflecting unit may reflect only fluorescence generated at the inner wall and transmit light having wavelengths that are not required to make a diagnosis of the body cavity (for example, excitation light emitted from the irradiation unit).

In the above-described structure, a rotary drive unit that rotates the reflecting unit may be provided.

Thus, the reflecting unit may be rotated to reflect, toward the image-acquisition unit, the fluorescence generated at partial areas of the inner wall of the body cavity located in a plurality of different radial directions of the insertion portion, and to cause the image-acquisition unit to acquire an image with the fluorescence.

Note that the rotary drive unit may rotate only the reflecting unit or it may rotate the light emitting and introducing unit that includes the reflecting unit. For example, the rotary drive unit may be formed in a tubular shape having the light emitting and introducing unit and may be disposed so as to be rotatable with respect to the insertion portion.

The above-described invention may be configured such that: the light emitting and introducing unit includes: a rotating unit that is disposed inside at least the tip of the insertion portion so as to be rotatable about the central axis of the insertion portion; an irradiation unit that is provided in the rotating unit and that emits the excitation light outward in radial directions of the insertion portion; and a reflecting unit that is provided in the rotating unit and that reflects the fluorescence generated at the inner wall in the direction of the central axis; and the image-acquisition unit is provided in the rotating unit and acquires the image with the fluorescence reflected by the reflecting unit.

Thus, excitation light is emitted from the irradiation unit provided in the rotating unit outward in radial directions of the insertion portion to irradiate the inner wall of the body cavity. The inner wall of the body cavity irradiated with the excitation light generates fluorescence. The fluorescence passes through the insertion portion to enter the rotating unit.

The fluorescence entering the rotating unit is reflected in the direction of the central axis of the insertion portion by the reflecting unit provided in the rotating unit. The image-acquisition unit acquires an image with the fluorescence reflected by the reflecting unit. The image-acquisition unit obtains the image of a partial area of the inner wall located in the radial directions of the insertion portion. Since the rotating unit is disposed inside the insertion portion so as to be rotatable about the central axis of the insertion portion, the fluorescence can enter the insertion portion from a plurality of different radial directions of the insertion portion. Therefore, according to the present invention, it is possible to acquire an image with the fluorescence generated at the inner wall of the body cavity located in the plurality of different radial directions of the insertion portion.

The above-described invention may be configured such that: the light emitting and introducing unit includes: a rotating unit that is disposed inside at least the tip of the insertion portion so as to be rotatable about the central axis of the insertion portion; and an irradiation unit that is provided in the rotating unit and that emits the excitation light outward in radial directions of the insertion portion; and the image-acquisition unit acquires the image with fluorescence introduced to the inside of the rotating unit.

Thus, excitation light is emitted from the irradiation unit provided in the rotating unit outward in radial directions of the insertion portion to irradiate the inner wall of the body cavity. The inner wall of the body cavity irradiated with the excitation light generates fluorescence. The fluorescence passes through the insertion portion to enter the rotating unit.

The image-acquisition unit provided in the rotating unit acquires an image with the fluorescence entering the rotating unit. Since the rotating unit is disposed inside the insertion portion so as to be rotatable about the central axis of the insertion portion, the fluorescence can enter the insertion portion from a plurality of different radial directions of the insertion portion. Therefore, according to the present invention, it is possible to acquire an image with the fluorescence generated at the inner wall of the body cavity located in the plurality of different radial directions of the insertion portion.

The above-described invention may be configured such that: the light emitting and introducing unit includes: an irradiation unit that emits the excitation light outward in the radial directions of the insertion portion; and a conical mirror that reflects the fluorescence generated at the inner wall in the direction of the central axis of the insertion portion; and the image-acquisition unit acquires the image with the fluorescence reflected by the conical mirror.

Thus, excitation light is emitted from the irradiation unit outward in the radial directions of the insertion portion to irradiate the inner wall of the body cavity. The inner wall of the body cavity irradiated with the excitation light generates fluorescence. The fluorescence enters the insertion portion via the light emitting and introducing unit.

The fluorescence entering the light emitting and introducing unit is reflected in the direction of the central axis of the insertion portion by the conical mirror provided in the light emitting and introducing unit. The image-acquisition unit acquires an image with the fluorescence. The conical mirror can introduce the fluorescence to the inside of the insertion portion from a plurality of different radial directions of the insertion portion. As a result, it is possible to acquire an image with the fluorescence generated at the inner wall of the body cavity located in the plurality of different radial directions of the insertion portion.

The above-described invention may further include: an insertion-length measurement unit that measures an insertion length of the insertion portion with respect to the body cavity; and an image processing unit that applies unrolling processing to the image-acquisition signal based on the image-acquisition signal output from the image-acquisition unit and a signal indicating the insertion length output from the insertion-length measurement unit.

Thus, the moving distance of the image-acquisition unit with respect to the body cavity is measured by the insertion-length measurement unit. The insertion-length measurement unit outputs a signal indicating an insertion length to the image processing unit. The image processing unit receives a image-acquisition signal output from the image-acquisition unit and the signal indicating the insertion length output from the insertion-length measurement unit and applies processing to an image-acquisition signal based on the received signals.

For example, when the image-acquisition signal output from the image-acquisition unit indicates a fluorescence image of the entire face of the inner circumference of the inner wall, reflected at the conical mirror, the image processing unit can convert the signal indicating the fluorescence image reflected at the conical mirror to a signal indicating an unrolled fluorescence image of the body cavity.

The above-described invention may further include: an inflow unit that supplies fluid to the balloon; a flow measurement unit that measures the flow of the fluid supplied to the balloon; and a calculation unit that calculates the distance between the insertion portion and the contact surface of the balloon that is brought into contact with the inner wall, based on a flow signal output from the flow measurement unit, in which the correction-signal calculating unit calculates the correction signal based on the distance calculated by the calculation unit.

Thus, the inflow unit supplies fluid to the balloon. The balloon inflated with the supplied fluid is brought into contact with the inner wall of the body cavity located in the radial directions of the insertion portion, thereby positioning the insertion portion approximately at the center of the body cavity. The volume of the inflated balloon can be calculated from the flow of the fluid supplied to the balloon. Therefore, the calculation unit can easily calculate the distance between the insertion portion and the contact surface of the balloon that is brought into contact with the inner wall, based on a flow signal measured by the flow measurement unit.

Then, the correction-signal calculating unit calculates a correction signal based on the distance calculated by the calculation unit, thereby generating the same image signal as that generated when the distance from the inner wall to the image-acquisition unit is maintained at the predetermined constant distance.

The above-described invention may be configured such that: a fluorescence agent is disposed on the contact surface of the balloon that is brought into contact with the inner wall; a fluorescence detecting unit that detects the intensity of fluorescence generated at the fluorescence agent is provided; and the correction-signal calculating unit calculates the correction signal based on the distance calculated by the calculation unit.

Thus, excitation light emitted outward in the radial directions of the insertion portion irradiates the fluorescence agent disposed on the contact surface of the balloon that is brought in contact with the inner wall. The fluorescence agent irradiated with the excitation light generates fluorescence. The fluorescence intensity of the generated fluorescence is detected by the fluorescence detecting unit. Since the fluorescence intensity is inversely proportional to the square of the distance from the fluorescence agent, a fluorescence-intensity signal output from the fluorescence detecting unit can be regarded as a signal indicating the distance between the fluorescence agent and the fluorescence detecting unit.

Therefore, the correction-signal calculating unit calculates the correction signal based on the fluorescence-intensity signal, thereby generating the same image signal as that generated when the distance from the inner wall to the image-acquisition unit is maintained at the predetermined constant distance.

The above-described invention may be configured such that: the fluid supplied to the balloon is liquid; an ultrasonic-signal generator that emits ultrasonic waves toward the contact surface of the balloon that is brought into contact with the inner wall is provided; an ultrasonic-signal detector that detects ultrasonic waves reflected by the contact surface is provided; a control unit that controls the ultrasonic-signal generator and also calculates the distance between the insertion portion and the contact surface of the balloon that is brought into contact with the inner wall, based on a detection signal output from the ultrasonic-signal detector, is provided; and the correction-signal calculating unit calculates the correction signal based on the distance calculated by the control unit.

Thus, ultrasonic waves are emitted by the ultrasonic-signal generator toward the contact surface of the balloon and propagate through the balloon filled with liquid. Since the balloon is filled with liquid, the attenuation rate of the ultrasonic waves is reduced compared with a case where the balloon is filled with air. The ultrasonic waves propagating through the balloon are reflected at the contact surface and detected by the ultrasonic-signal detector.

The control unit controls the ultrasonic-signal generator to control the emitted ultrasonic waves and also receives a detection signal output from the ultrasonic-signal detector. Therefore, the control unit can calculate the distance between the contact surface and the insertion portion based on the phase difference between the phase of the ultrasonic waves emitted by the ultrasonic-signal generator and the phase of the ultrasonic waves detected by the ultrasonic-signal detector.

In this way, the correction-signal calculating unit calculates a correction signal based on the distance calculated by the control unit, thereby generating the same image signal as that generated when the distance from the inner wall to the image-acquisition unit is maintained at the predetermined constant distance.

The above-described invention may further include: a microwave-signal generator that emits microwaves toward the contact surface of the balloon that is brought into contact with the inner wall; a microwave-signal detector that detects microwaves reflected by the contact surface; and a control unit that controls the microwave-signal generator and also calculates the distance between the insertion portion and the contact surface of the balloon that is brought into contact with the inner wall, based on a detection signal output from the microwave-signal detector, in which the correction-signal calculating unit calculates the correction signal based on the distance calculated by the control unit.

Thus, microwaves are emitted by the microwave-signal generator toward the contact surface of the balloon and propagate through the balloon. The microwaves propagate through the balloon at a lower attenuation rate than ultrasonic waves. The microwaves propagating through the balloon are reflected at the contact surface and detected by the microwave-signal detector.

The control unit controls the microwave-signal generator to control the emitted microwaves and also receives a detection signal output from the microwave-signal detector. Therefore, the control unit can calculate the distance between the contact surface and the insertion portion based on the phase difference between the phase of the microwaves emitted by the microwave-signal generator and the phase of the microwaves detected by the microwave-signal detector.

As described above, the correction-signal calculating unit calculates a correction signal based on the distance calculated by the control unit, thereby generating the same image signal as that generated when the distance from the inner wall to the image-acquisition unit is maintained at the predetermined constant distance.

According to the fluorescence endoscope of the present invention, even if the observation distance between the insertion portion and the entire face of the inner circumference of the body cavity serving as the subject is changed, it is possible to generate the same image signal as that generated when a predetermined distance is maintained between the insertion portion and the entire face of the inner circumference of the body cavity. Therefore, it can be easily judged whether body cavity tissue is benign tissue or malignant tissue.

### BRIEF DESCRIPTION OF DRAWINGS

FIG. 1 is a view for explaining the structure of a fluorescence endoscope according to a first embodiment of the present invention.

FIG. 2 is a view for explaining the structure of an insertion portion shown in FIG. 1.

FIG. 3 is a perspective view for explaining the structure of an irradiation lens shown in FIG. 2.

FIG. 4 is a perspective view for explaining the structure of a irradiation mirror shown in FIG. 2.

FIG. 5 is a cross-sectional view along a line A-A for explaining the structure of a holding part shown in FIG. 2.

FIG. 6 is a flowchart for explaining a control method of a distance measuring unit shown in FIG. 1.

FIG. 7 is a flowchart for explaining a processing method used by a fluorescence-signal processing unit shown in FIG. 1.

FIG. 8 is a view for explaining the structure of a fluorescence endoscope according to a first modification of the first embodiment of the present invention.

FIG. 9 is a view for explaining the structure of a conical mirror shown in FIG. 8.

FIG. 10 is a view showing a fluorescence image acquired by an image-acquisition device shown in FIG. 8.

FIG. 11 is a view showing an image obtained after conversion processing is applied by a fluorescence-signal processing unit shown in FIG. 8.

FIG. 12 is a view for explaining the structure of a fluorescence endoscope according to a second modification of the first embodiment of the present invention.

FIG. 13 is a view for explaining the structure of an insertion portion shown in FIG. 12.

FIG. 14 is a view for explaining the structure of a fluorescence endoscope according to a third modification of the first embodiment of the present invention.

FIG. 15 is a view for explaining the structure of an insertion portion shown in FIG. 14.

FIG. 16 is a view for explaining the structure of a fluorescence endoscope according to a fourth modification of the first embodiment of the present invention.

FIG. 17 is a view for explaining the structure of an insertion portion shown in FIG. 16.

FIG. 18 is a front view for explaining the structure of the insertion portion shown in FIG. 17.

FIG. 19 is a view for explaining the structure of a fluorescence endoscope according to a fifth modification of the first embodiment of the present invention.

FIG. 20 is a view for explaining the structure of an insertion portion shown in FIG. 19.

FIG. 21 is a view for explaining the structure of a fluorescence endoscope according to a sixth modification of the first embodiment of the present invention.

FIG. 22 is a view for explaining another structure for the fluorescence endoscopes shown in FIGS. 1 to 21.

FIG. 23 is a view for explaining still another structure for the fluorescence endoscopes shown in FIGS. 1 to 21.

FIG. 24 is a view for explaining still another structure for the fluorescence endoscopes shown in FIGS. 1 to 21.

FIG. 25 is a view for explaining the structure of a fluorescence endoscope according to a second embodiment of the present invention.

FIG. 26 is a view for explaining the structure of an insertion portion shown in FIG. 25.

FIG. 27 is a view for explaining the structure of a fluorescence endoscope according to a first modification of the second embodiment of the present invention.

FIG. 28 is a view for explaining the structure of an insertion portion shown in FIG. 27.

FIG. 29 is a view for explaining the structure of a fluorescence endoscope according to a second modification of the second embodiment of the present invention.

FIG. 30 is a view for explaining the structure of an insertion portion shown in FIG. 29.

### EXPLANATION OF REFERENCE SIGNS

1, 101, 201, 301, 401, 501, 601, 701, 801, 901: fluorescence endoscope
3: body cavity
5, 105, 205, 305, 405, 505, 605, 705, 805, 905: insertion portion
15: balloon
17, 217, 417, 517: light emitting part (light emitting and introducing unit)
19, 119, 219: light introducing part (light emitting and introducing unit)
21, 421, 521: image-acquisition unit
33, 233: irradiation mirror (irradiation unit)
35: dichroic mirror (reflecting unit)
37: drive motor (rotary drive unit)
49: air supply pump (inflow unit)
51: flowmeter (flow measurement unit)
53, 653: distance measuring unit (calculation unit)
57: fluorescence-signal processing unit (correction-signal calculating unit, signal processing unit)
135: conical mirror (reflecting unit)
157: fluorescence-signal processing unit (correction-signal calculating unit, signal processing unit, image processing unit)
161: image sensor (insertion-length measurement unit)
213A, 613A, 713A, 813A: outer insertion portion (insertion portion)
213B, 313B, 413B, 613B, 713B, 813B, 913B: inner insertion portion (light emitting and introducing unit, rotating unit)
533: irradiation mirror (irradiation unit)
624: fluorescence detecting unit
724: ultrasonic-wave generating and measuring unit (ultrasonic-signal generator, ultrasonic-signal detector)
749: pump (inflow unit)
754, 854: control unit
824: microwave generating and measuring unit (microwave-signal generator, microwave-signal detector)

### BEST MODE FOR CARRYING OUT THE INVENTION

### First Embodiment

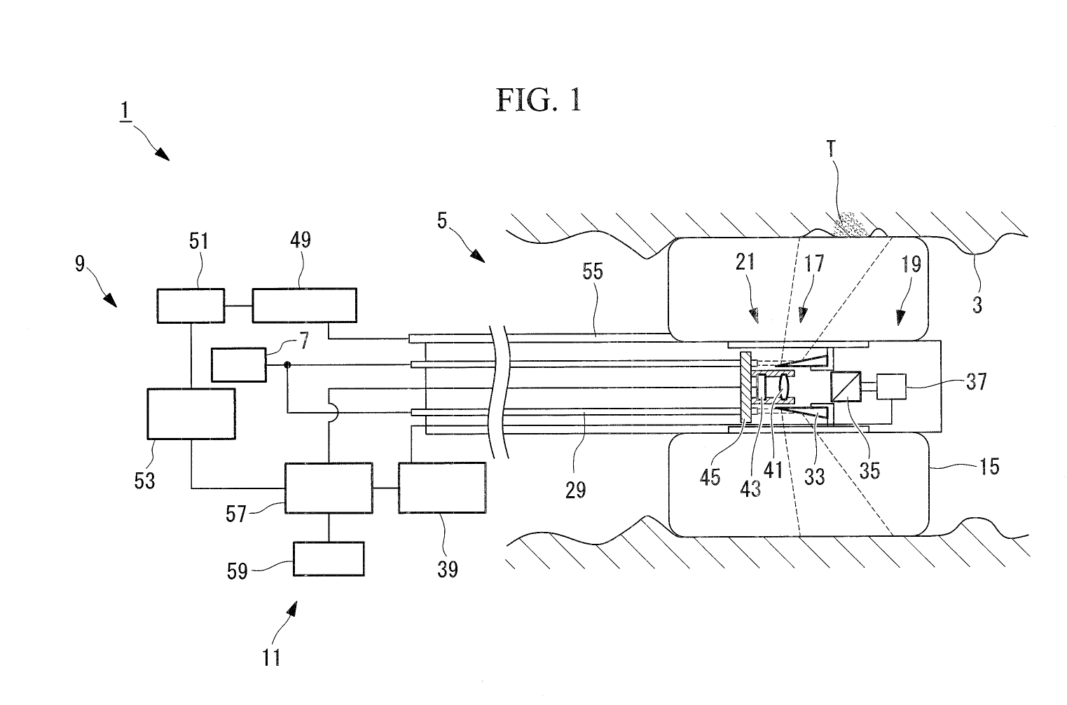

A fluorescence endoscope according to a first embodiment of the present invention will be described below with reference to FIGS. 1 to 7.

FIG. 1 is a view for explaining the structure of the fluorescence endoscope of this embodiment.

As shown in FIG. 1, a fluorescence endoscope 1 includes an insertion portion 5 that is to be inserted into a body cavity 3 of a subject, a light source 7 that emits excitation light, a measurement control unit 9 that measures the distance between the insertion portion 5 and an inner wall of the body cavity 3, and a display unit 11 that displays an acquired fluorescence image.

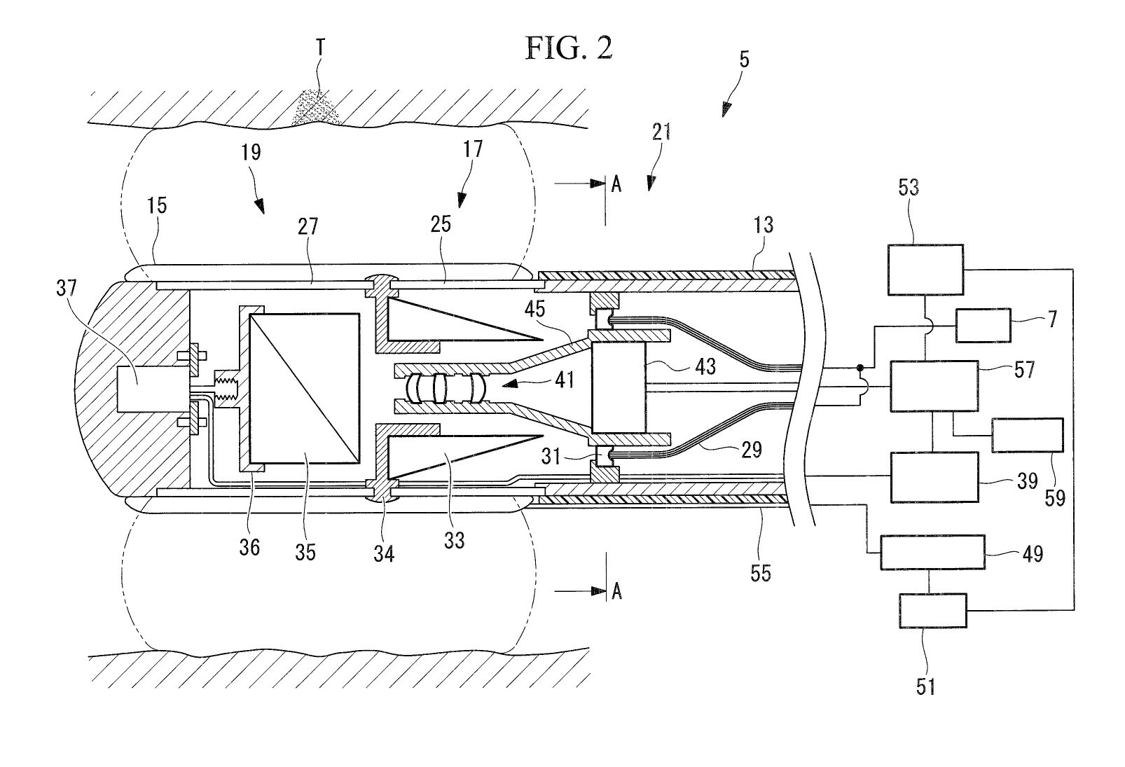

FIG. 2 is a view for explaining the structure of the insertion portion shown in FIG. 1.

The insertion portion 5 is inserted into the body cavity 3 of the subject and observes fluorescence generated at the inner wall of the body cavity 3. As shown in FIG. 2, the insertion portion 5 is provided with a casing tube 13, a balloon 15, a light emitting part (light emitting and introducing unit) 17, a light introducing part (light emitting and introducing unit) 19, and an image-acquisition unit 21.

The casing tube 13 serves as an outer circumferential face of the insertion portion 5. An excitation-light window 25 that transmits excitation light and a fluorescence window 27 that transmits fluorescence are provided at the insertion end (the left end of FIG. 2) of the casing tube 13. The balloon 15 is disposed on the outer circumferential faces of the excitation-light window 25 and the fluorescence window 27. The light emitting part 17, the light introducing part 19, the image-acquisition unit 21, and a holding part 45 are disposed inside the casing tube 13. The fluorescence window 27 is disposed closer to the insertion end of the casing tube 13 than the excitation-light window 25. The excitation-light window 25 is a member formed in an approximately cylindrical shape and is made from a material that transmits excitation light emitted by the light source 7. The fluorescence window 27 is a member formed in an approximately cylindrical shape and is made from a material that transmits fluorescence generated at the body cavity 3.

The balloon 15 is inflated in the body cavity 3, thereby securing the insertion portion 5 to the body cavity 3 and also positioning the insertion end of the insertion portion 5 approximately at the center of the body cavity tract. As shown in FIG. 2, the balloon 15 is disposed on the outer circumferential faces of the excitation-light window 25 and the fluorescence window 27 of the casing tube 13 and is made from a material that transmits excitation light passing through the excitation-light window 25 and fluorescence passing through the fluorescence window 27. The balloon 15 is connected to an air supply pump 49 of the measurement control unit 9, to be described later.

In FIG. 2, the balloon 15 before being inflated is indicated by a solid line, and the balloon 15 after being inflated is indicated by a two-dot chain line.

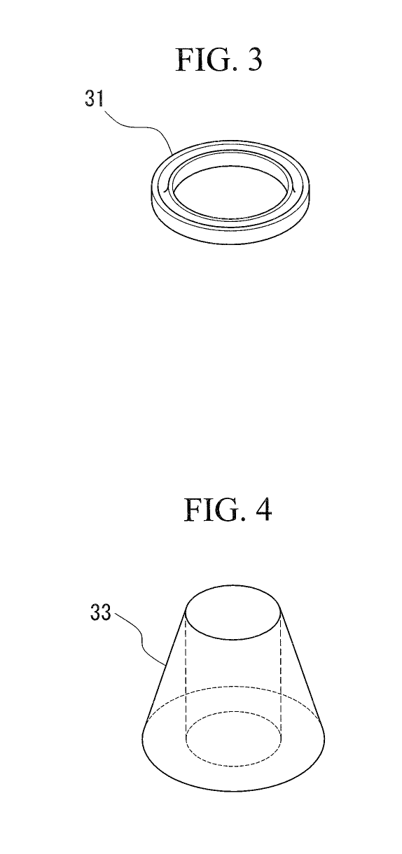

FIG. 3 is a perspective view for explaining the structure of an irradiation lens shown in FIG. 2. FIG. 4 is a perspective view for explaining the structure of a irradiation mirror shown in FIG. 2.

The light emitting part 17 emits excitation light emitted by the light source 7 toward the inner wall of the body cavity 3. As shown in FIG. 2, the light emitting part 17 includes a light guide 29, an irradiation lens 31, and an irradiation mirror (irradiation unit) 33. Note that it is preferable that the light emitting part 17 be able to simultaneously emit excitation light to the entire circumferential face of the inner wall.

The light guide 29 guides excitation light emitted by the light source 7 to the irradiation lens 31 disposed at the insertion end of the insertion portion 5. The light guide 29 is constituted by a bundle of fibers that guide excitation light and is formed in an approximately cylindrical shape.

The irradiation lens 31 is used to irradiate the entire observation area of the body cavity 3 with the excitation light. The irradiation lens 31 is disposed at the insertion end of the insertion portion 5 between the light guide 29 and the irradiation mirror 33. The irradiation lens 31 is formed such that it has a circular ring shape as shown in FIG. 3, and also has a concave gutter on the surface facing the light guide 29.

The irradiation mirror 33 reflects the excitation light emitted in the direction of the central axis of the insertion portion 5 by the irradiation lens 31 toward the outside in the radial directions of the insertion portion 5. The irradiation mirror 33 is disposed inside the casing tube 13 at a location facing the excitation-light window 25. As shown in FIG. 4, the irradiation mirror 33 is formed such that it has an approximately conical shape with its conical surface being used as a reflecting surface and has a through-hole along the central axis. The irradiation mirror 33 is held by a mirror holding part 34.

The light introducing part 19 reflects fluorescence generated at the body cavity 3 toward the image-acquisition unit 21. As shown in FIG. 2, the light introducing part 19 includes a dichroic mirror (reflecting unit) 35, a drive motor (rotary drive unit) 37, and a motor control unit 39.

The dichroic mirror 35 reflects fluorescence that has passed through the fluorescence window 27 in the direction along the central axis of the insertion portion 5 and transmits light having wavelengths other than that of the fluorescence, which is to be used for acquiring an image in the image-acquisition unit 21. The dichroic mirror 35 is disposed inside the casing tube 13 at a location facing the fluorescence window 27, so as to be rotatable about the central axis of the insertion portion 5. The dichroic mirror 35 is formed in a rectangular parallel piped shape and reflects fluorescence generated at a partial area of the body cavity 3 toward the image-acquisition unit 21. The dichroic mirror 35 is held by a dichroic-mirror holding part 36. Note that any known mirror can be used as the dichroic mirror 35; the dichroic mirror 35 is not particularly limited.

The drive motor 37 rotationally drives the dichroic mirror 35 about the central axis of the insertion portion 5. The drive motor 37 is disposed at the tip of the insertion portion 5 and connected to the motor control unit 39. Note that any known motor can be used as the drive motor 37; the drive motor 37 is not particularly limited.

The motor control unit 39 controls the rotation of the drive motor 37, thereby controlling the rotation of the dichroic mirror 35. The motor control unit 39 outputs a phase signal of the dichroic mirror 35 to the fluorescence-signal processing unit 57 and also outputs a control signal to the drive motor 37.

The image-acquisition unit 21 acquires an image with the fluorescence generated at the body cavity 3. The image-acquisition unit 21 includes an image-acquisition lens system 41 and an image-acquisition device 43 as shown in FIG. 2.

The image-acquisition lens system 41 forms an image with the fluorescence reflected by the dichroic mirror 35 on a light receiving surface of the image-acquisition device 43. The image-acquisition lens system 41 is disposed between the dichroic mirror 35 and the image-acquisition device 43 and is also disposed inside the irradiation mirror 33, in other words, on the central axis of the insertion portion 5. In this embodiment, a description is given of the image-acquisition lens system 41 constituted by a plurality of lenses, as shown in FIG. 2. However, the description does not particularly limit the structure of the image-acquisition lens system 41.

The image-acquisition device 43 acquires an image with the fluorescence generated at the body cavity 3. The image-acquisition device 43 is disposed inside the irradiation lens 31, in other words, on the central axis of the insertion portion 5, and is connected to the fluorescence-signal processing unit 57 of the display unit 11. Note that any known device, such as a CCD (charge coupled device) or a CMOS (complementary metal oxide semiconductor) device, can be used as the image-acquisition device 43; the image-acquisition device 43 is not particularly limited.

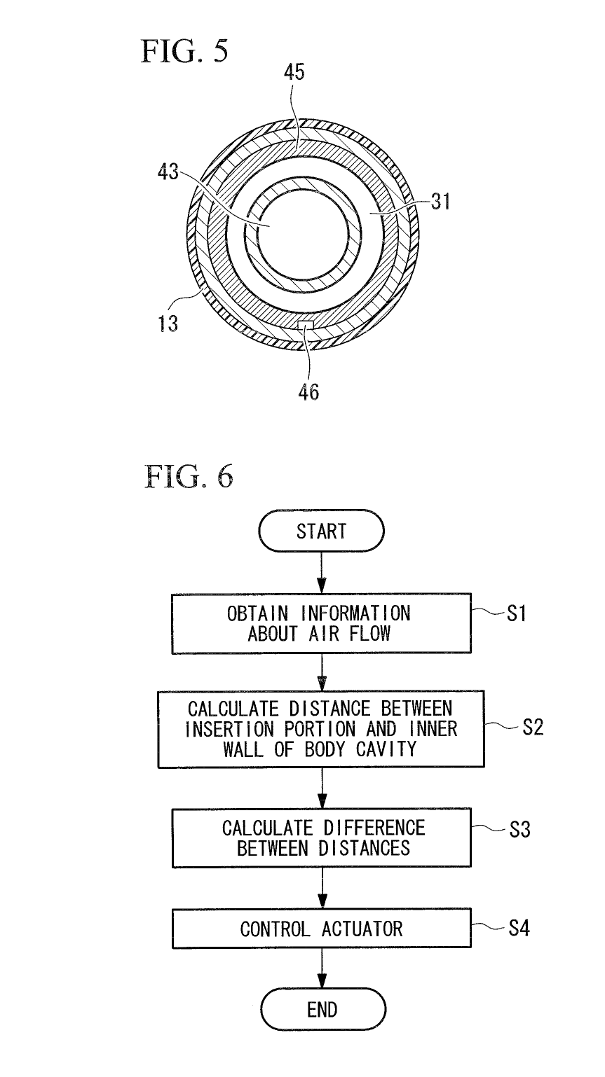

FIG. 5 is a cross-sectional view along a line A-A for explaining the structure of the holding part shown in FIG. 2.

The holding part 45 holds the irradiation lens 31, the image-acquisition lens system 41, and the image-acquisition device 43 and prevents the excitation light emitted by the irradiation lens 31 from being directly incident on the image-acquisition device 43. As shown in FIG. 5, the holding part 45 is provided with a gutter part 46 through which a signal line for transmitting a control signal from the motor control unit 39 to the drive motor 37 passes.

As shown in FIG. 1, the light source 7 emits excitation light that irradiates the body cavity 3 and that causes the body cavity 3 to generate fluorescence. In particular, the light source 7 emits excitation light that causes a lesion T of the body cavity 3 to generate high-intensity fluorescence. The excitation light emitted by the light source 7 is incident on the light guide 29 in the insertion portion 5.

The measurement control unit 9 measures the distance between the insertion portion 5 and the inner wall of the body cavity 3. As shown in FIG. 1, the measurement control unit 9 includes the air supply pump (inflow unit) 49, a flowmeter (flow measurement unit) 51, and a distance measuring unit (calculation unit) 53.

The air supply pump 49 inflates the balloon 15 by supplying air (fluid). The air supplied by the air supply pump 49 is sent to the balloon 15 through an air supply tube 55 disposed on the outer circumferential face of the casing tube 13. A flow signal of the air supply pump 49 is output to the flowmeter 51. Note that any known pump can be used as the air supply pump 49; the air supply pump 49 is not particularly limited.

The flowmeter 51 measures the flow of air supplied from the air supply pump 49 to the balloon 15. Specifically, the flowmeter 51 measures the air flow based on the flow signal of the air supply pump 49. The flow signal indicates information necessary to calculate the flow of supplied air, and includes, for example, the time during which the air supply pump 49 is driven or the rotating speed of the pump. A signal indicating the air flow measured by the flowmeter 51 is output to the distance measuring unit 53.

The distance measuring unit 53 measures the distance between the insertion portion 5 and the inner wall of the body cavity 3. The distance measuring unit 53 receives the signal indicating the air flow from the flowmeter 51 and can calculate the distance between the insertion portion 5 and the inner wall of the body cavity 3 based on the signal. The distance measuring unit 53 outputs to the fluorescence-signal processing unit 57 a distance signal indicating the distance between the insertion portion 5 and the inner wall of the body cavity 3.

The display unit 11 displays a fluorescence image acquired by the image-acquisition unit 21. The display unit 11 includes the fluorescence-signal processing unit (correction-signal calculating unit, signal processing unit) 57 and a monitor 59, as shown in FIG. 1.

The fluorescence-signal processing unit 57 converts an image-acquisition signal output from the image-acquisition device 43 to an image signal to be displayed on the monitor 59. The fluorescence-signal processing unit 57 receives the image-acquisition signal output from the image-acquisition device 43, the phase signal of the dichroic mirror 35 output from the motor control unit 39, and the distance signal output from the distance measuring unit 53. The fluorescence-signal processing unit 57 outputs the image signal to the monitor 59.

Next, a description will be given of a method of acquiring an image of the inner wall of the body cavity 3, used by the fluorescence endoscope 1 having the above-described structure.

First, the insertion portion 5 of the fluorescence endoscope 1 is inserted into the body cavity 3. At this time, as indicated by the solid line in FIG. 2, the balloon 15 is deflated so as not to interfere with the insertion and is in close contact with the outer circumferential face of the insertion portion 5.

When the insertion end of the insertion portion 5 reaches an area to be examined in the body cavity 3, the air supply pump 49 supplies air to the balloon 15, and the balloon 15 is inflated to press against the inner wall of the body cavity 3. The insertion portion 5 is secured to the body cavity 3 with the balloon 15, and the insertion end of the insertion portion 5 is positioned approximately at the center of the tract of the body cavity 3. The air supply pump 49 keeps supplying air until the pressure in the balloon 15 reaches a predetermined pressure, and stops supplying air after the pressure reaches the predetermined pressure.

Since the balloon 15 is filled with air having the predetermined pressure, the balloon 15 presses against the inner wall of the body cavity 3 toward the outside in the radial directions. For example, when there are folds on the inner wall of the body cavity 3, as in the large intestine, the folds are smoothed out when pressed by the balloon 15. Therefore, it is possible to smooth out the folds on the inner wall of the body cavity 3 to observe areas that were invisible between the folds.

FIG. 6 is a flowchart for explaining a control method of a distance measuring unit shown in FIG. 1.

The flowmeter 51 measures the air flow based on a flow signal output from the air supply pump 49 and outputs information about the air flow to the distance measuring unit 53 (Step S1). The distance measuring unit 53 calculates the outer diameter of the balloon 15 based on the received information about the air flow, thereby measuring the distance between the insertion portion 5 and the inner wall of the body cavity 3 (Step S2).

Specifically, the distance measuring unit 53 stores a look-up table holding the flow of air supplied to the balloon 15, and the distance between the insertion portion 5 and the inner wall of the body cavity 3 corresponding to the flow. With reference to the look-up table, the distance measuring unit 53 can calculate the distance between the insertion portion 5 and the inner wall of the body cavity 3. Data included in the look-up table can be obtained in advance through actual experimental measurements, for example.

The distance measuring unit 53 generates a distance signal to be output to the fluorescence-signal processing unit 57, based on the calculated distance between the insertion portion 5 and the inner wall of the body cavity 3. In other words, the distance measuring unit 53 controls the relative position of the holding part 45 with respect to the casing tube 13 such that the distance between the image-acquisition device 43 and the inner wall of the body cavity 3 is a predetermined constant distance.

Specifically, first, the distance measuring unit 53 calculates the current distance from the inner wall of the body cavity 3 to the image-acquisition device 43 based on: the distance from the inner wall of the body cavity 3 to the dichroic mirror 35, which is calculated from the calculated the distance between the insertion portion 5 and the inner wall of the body cavity 3; and the distance from the dichroic mirror 35 to the image-acquisition device 43, which is calculated based on the relative position of the holding part 45 with respect to the casing tube 13. Then, the distance measuring unit 53 calculates the difference between the calculated distance and the predetermined constant distance (Step S3) and outputs a signal (distance signal) indicating the difference to the fluorescence-signal processing unit 57 (Step S4). For example, when the calculated distance is longer than the predetermined constant distance, the distance measuring unit 53 outputs a distance signal that includes positive-sign information and the absolute value of the difference between the calculated distance and the predetermined constant distance. On the other hand, when the calculated distance is shorter than the predetermined constant distance, it outputs a distance signal that includes negative-sign information and the absolute value of the difference between the calculated distance and the predetermined constant distance.

After that, the light source 7 emits excitation light. The excitation light is guided by the light guide 29 in the casing tube 13 to the tip of the insertion portion 5. The excitation light is emitted from the light guide 29 in the direction along the central axis of the insertion portion 5 and passes through the irradiation lens 31 to be incident on the irradiation mirror 33. The excitation light incident on the irradiation mirror 33 is reflected toward the outside in the radial directions of the insertion portion 5 and passes through the excitation-light window 25 and the balloon 15 to be incident on the body cavity 3. The excitation light passes through the irradiation lens 31, thereby illuminating the entire face of an observation area of the body cavity 3.

The body cavity 3 on which the excitation light was incident generates fluorescence. In particular, the lesion T generates a larger amount of fluorescence than a normal part of the body cavity 3. The fluorescence passes through the balloon 15 and the fluorescence window 27 to enter the casing tube 13. Of the entering fluorescence, fluorescence incident on the dichroic mirror 35 is reflected in the direction of the central axis of the insertion portion 5. Light having wavelengths other than that of the fluorescence incident on the dichroic mirror 35 passes through the dichroic mirror 35 without being reflected.

The image-acquisition lens system 41 forms an image with the fluorescence reflected by the dichroic mirror 35 on the light receiving surface of the image-acquisition device 43. Based on the formed fluorescence image, the image-acquisition device 43 outputs an image-acquisition signal to the fluorescence-signal processing unit 57.

The dichroic mirror 35 is rotated and controlled by the motor control unit 39. Specifically, the motor control unit 39 controls the rotation of the drive motor 37, thereby controlling the phase of the dichroic mirror 35. When the dichroic mirror 35 is controlled and rotated about the central axis of the insertion portion 5, the fluorescence generated at the entire face of the inner wall of the body cavity 3 is incident on the image-acquisition device 43.

At the same time, the motor control unit 39 outputs a signal indicating the rotational phase of the dichroic mirror 35 to the fluorescence-signal processing unit 57.

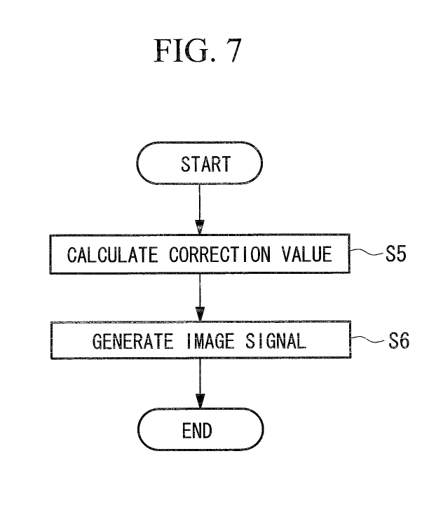

FIG. 7 is a flowchart for explaining a processing method used by the fluorescence-signal processing unit shown in FIG. 1.

The fluorescence-signal processing unit 57 calculates an image signal based on the distance signal received from the distance measuring unit 53, the image-acquisition signal received from the image-acquisition device 43, and the signal indicating the rotational phase received from the motor control unit 39.

First, the fluorescence-signal processing unit 57 generates a correction signal based on the distance signal received from the distance measuring unit 53 (Step S5). For example, when the distance signal includes the positive-sign information, the fluorescence-signal processing unit 57 calculates, based on the absolute value of the difference included in the distance signal, a correction signal for controlling the degree of amplification for the intensity of fluorescence included in the image signal. On the other hand, when the distance signal includes the negative-sign information, the fluorescence-signal processing unit 57 calculates, based on the absolute value of the difference included in the distance signal, a correction signal for controlling the degree of reduction for the intensity of fluorescence included in the image signal.

Then, the fluorescence-signal processing unit 57 applies correction processing to the image-acquisition signal based on the calculated correction signal to generate an image signal (Step S6). The fluorescence-signal processing unit 57 applies correction processing to all signals indicating fluorescence intensities included in the image-acquisition signal, based on the correction signal, to generate an image signal. In other words, the fluorescence-signal processing unit 57 generates an image signal corresponding to the fluorescence intensity obtained through image-acquisition at the predetermined constant distance, irrespective of the actual distance from the inner wall of the body cavity 3 to the image-acquisition device 43.

The image-acquisition signal received from the image-acquisition device 43 indicates an image that is rotated in response to the rotation of the dichroic mirror 35. The fluorescence-signal processing unit 57 converts the image-acquisition signal indicating the rotated image to an image signal indicating a still image, based on the signal indicating the rotational phase.

The image signal, obtained through the correction processing and the conversion processing in the fluorescence-signal processing unit 57, is output from the fluorescence-signal processing unit 57 to the monitor 59 and is displayed on the monitor 59.

With the above-described structure, the balloon 15 is brought into contact with the inner wall of the body cavity 3 located in the radial directions of the insertion portion 5, thereby allowing the insertion portion 5 to be positioned approximately at the center of the body cavity 3. In other words, the balloon 15 can equalize the distances between the insertion portion 5 and all partial areas of the inner wall of the body cavity 3 in the radial directions of the insertion portion 5. The light emitting part 17 can emit excitation light outward in the radial directions of the insertion portion 5 to irradiate the inner wall of the body cavity 3, whose distances from the insertion portion 5 are equalized by the balloon 15. Therefore, the inner wall irradiated with the excitation light generates fluorescence. The fluorescence generated at the inner wall of the body cavity 3 passes through the balloon 15, travels inward in the radial directions of the insertion portion 5, and enters the insertion portion 5 via the light introducing part 19. If fluorescence is generated at a plurality of places on the inner wall of the body cavity 3, the fluorescence enters the insertion portion from a plurality of different radial directions of the insertion portion 5. Then, the image-acquisition device 43 of the image-acquisition unit 21 can acquire an image with the fluorescence entering the insertion portion 5 via the light introducing part 19.

The fluorescence-signal processing unit 57 can calculate a correction signal for correcting the image-acquisition signal output from the image-acquisition unit 21, based on the distance between the insertion portion 5 and the contact surface of the balloon 15 that is brought into contact with the inner wall. In other words, in response to a change in the distance between the insertion portion 5 and the contact surface of the balloon 15 that is brought into contact with the inner wall, the fluorescence-signal processing unit 57 calculates a different correction signal. Then, it is possible to correct the intensity of the image-acquisition signal output from the image-acquisition device 43 of the image-acquisition unit 21 based on the correction signal calculated by the fluorescence-signal processing unit 57 and to generate an image signal from the corrected image-acquisition signal.

In this way, it is possible to generate the same image signal as that generated when the predetermined distance is maintained between the contact surface and the insertion portion 5. With the use of this image signal, even if the distance between the contact surface and the insertion portion 5 is changed, it is possible to obtain the same fluorescence image as that obtained when the inner wall of the body cavity 3 is observed always at the predetermined distance. Therefore, it can be easily judged whether body cavity tissue is benign tissue or malignant tissue.

Excitation light is emitted outward in the radial directions of the insertion portion 5 by the irradiation mirror 33 provided in the light emitting part 17 to irradiate the inner wall of the body cavity 3 brought into contact with the balloon 15. The inner wall of the body cavity 3 irradiated with the excitation light generates fluorescence. The fluorescence enters the insertion portion 5. The fluorescence entering the insertion portion 5 is reflected in the direction of the central axis of the insertion portion 5 by the dichroic mirror 35 provided in the light introducing part 19. Since the dichroic mirror 35 is disposed so as to be rotatable about the central axis, the fluorescence generated at the inner wall of the body cavity 3 located in a plurality of different radial directions of the insertion portion 5 is reflected in the direction of the central axis of the insertion portion 5. The image-acquisition device 43 of the image-acquisition unit 21 acquires an image with the fluorescence reflected by the dichroic mirror 35. The image-acquisition device 43 can obtain the image of a partial area of the inner wall located in the radial directions of the insertion portion 5.

When the dichroic mirror 35 is rotated, it is possible to reflect, toward the image-acquisition device 43, the fluorescence generated at partial areas of the inner wall of the body cavity 3 located in a plurality of different radial directions of the insertion portion 5, and to cause the image-acquisition device 43 to acquire an image with the fluorescence.

### First Modification of First Embodiment

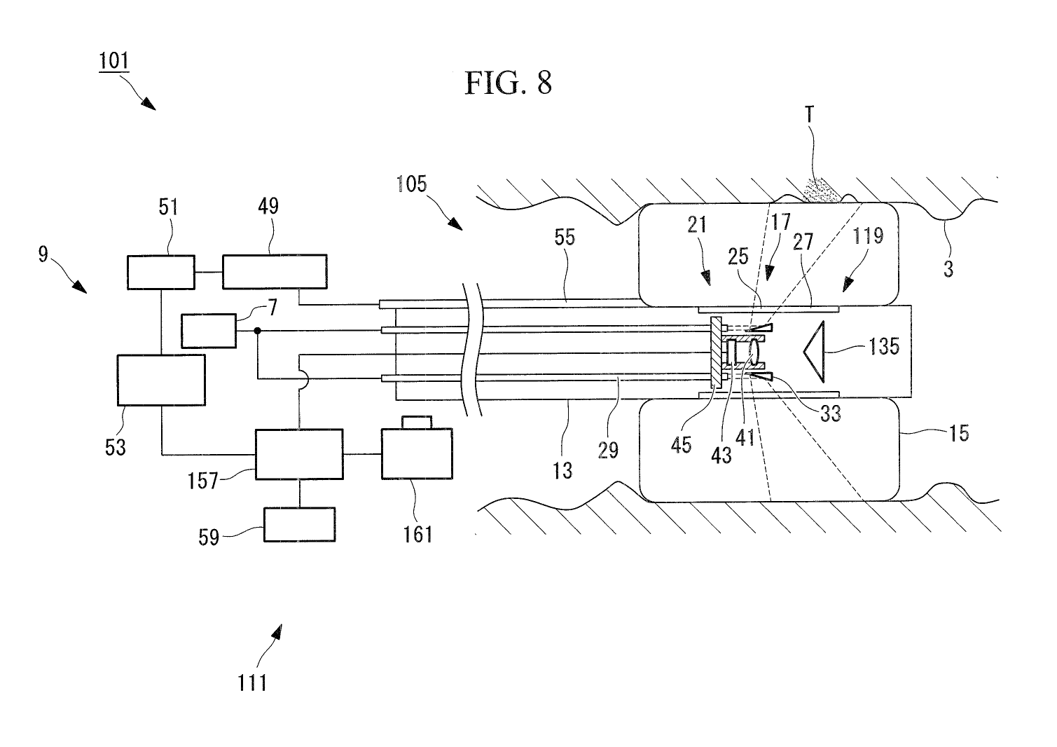

Next, a first modification of the first embodiment of the present invention will be described with reference to FIGS. 8 to 11.

Although the basic structure of a fluorescence endoscope of this modification is the same as that of the first embodiment, the structure of a reflecting unit of this modification is different from that of the first embodiment. Therefore, in this modification, only the reflecting unit and the components surrounding it will be described with reference to FIGS. 8 to 11, and a description of the other components will be omitted.

FIG. 8 is a view for explaining the structure of the fluorescence endoscope according to this modification.

Note that the same reference symbols are given to the same components as those of the first embodiment, and a description thereof will be omitted.

As shown in FIG. 8, a fluorescence endoscope 101 includes an insertion portion 105 that is to be inserted into the body cavity 3 of a subject, the light source 7 that emits excitation light, the measurement control unit 9 that measures the distance between the insertion portion 105 and the inner wall of the body cavity 3, and a display unit 111 that displays an acquired fluorescence image.

As shown in FIG. 8, the insertion portion 105 is provided with the casing tube 13, the balloon 15, the light emitting part (light emitting and introducing unit) 17, a light introducing part (light emitting and introducing unit) 119, and the image-acquisition unit 21.

The light introducing part 119 reflects fluorescence generated at the body cavity 3 toward the image-acquisition unit 21. The light introducing part 119 includes a conical mirror (reflecting unit) 135.

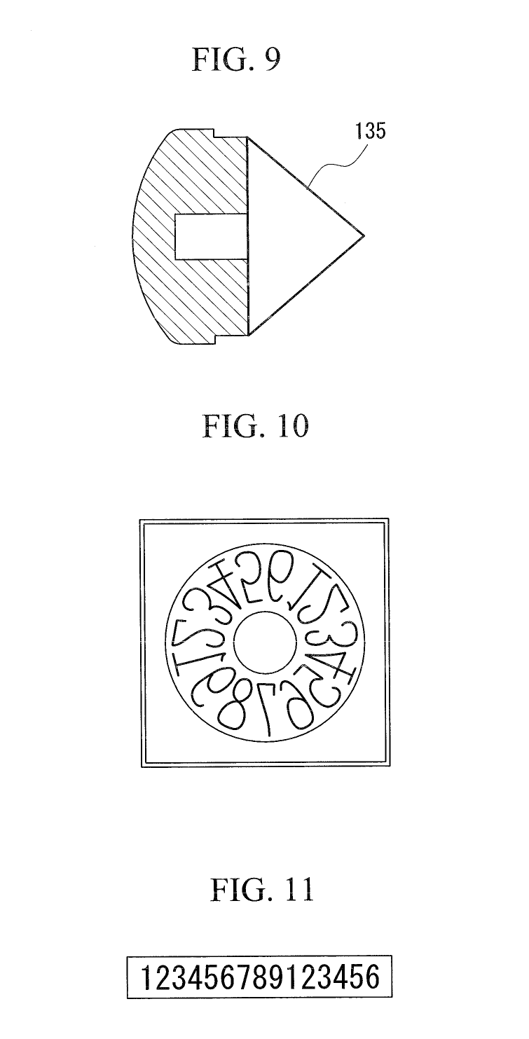

FIG. 9 is a view for explaining the structure of the conical mirror shown in FIG. 8.

The conical mirror 135 reflects fluorescence that has passed through the fluorescence window 27 in the direction along the central axis of the insertion portion 105. The conical mirror 135 is disposed in the casing tube 13 at a location facing the fluorescence window 27. As shown in FIG. 9, the conical mirror 135 is formed in a conical shape and its conical surface is used as a reflecting surface. Therefore, the conical mirror 135 reflects fluorescence generated at the entire face of the inner wall of the body cavity 3 toward the image-acquisition unit 21. The conical mirror 135 is disposed at the tip of the insertion portion 105.

The conical mirror 135 may have a truncated cone shape as long as it has a reflecting surface having a predetermined surface area.

As shown in FIG. 8, the display unit 111 displays a fluorescence image acquired by the image-acquisition unit 21. As shown in FIG. 8, the display unit 111 includes a fluorescence-signal processing unit (correction-signal calculating unit, signal processing unit, image processing unit) 157, the monitor 59, and an image sensor (insertion-length measurement unit) 161.

The fluorescence-signal processing unit 157 converts an image-acquisition signal output from the image-acquisition device 43 into an image signal to be displayed on the monitor 59. The fluorescence-signal processing unit 157 receives an image-acquisition signal output from the image-acquisition device 43 and a distance signal output from the distance measuring unit 53. The fluorescence-signal processing unit 157 outputs the image signal to the monitor 59.

The image sensor 161 measures the insertion length of the insertion portion 5 with respect to the body cavity 3. The image sensor 161 acquires an image of a scale provided on the insertion portion 105, thereby measuring the insertion length of the insertion portion 105. A signal indicating the insertion length is output from the image sensor 161 to the fluorescence-signal processing unit 157. Note that any known sensor can be used as the image sensor 161 and any known method can be used as the insertion-length calculation method; neither the image sensor 161 nor the insertion-length calculation method is particularly limited.

Next, a description will be given of a method of acquiring an image of the inner wall of the body cavity 3, used by the fluorescence endoscope 101 having the above-described structure.

Note that since a method of securing the insertion portion 105 with the balloon 15 is the same as that of the first embodiment, a description thereof will be omitted.

Since excitation light is emitted by the light source 7 to irradiate the body cavity 3 in the same way as in the first embodiment, a description thereof will also be omitted.

Fluorescence generated at the body cavity 3 passes through the balloon 15 and the fluorescence window 27 to enter the casing tube 13. The entering fluorescence is reflected by the conical mirror 135 in the direction of the central axis of the insertion portion 105. In other words, fluorescence generated at the entire inner circumferential face of an area of the body cavity 3 that faces the fluorescence window 27 is incident on the conical mirror 135 and reflected toward the image-acquisition device 43.

The image-acquisition lens system 41 forms an image with the fluorescence reflected by the conical mirror 135 on the light receiving surface of the image-acquisition device 43. The image-acquisition device 43 outputs an image-acquisition signal to the fluorescence-signal processing unit 157 based on the formed fluorescence image.

FIG. 10 is a view showing a fluorescence image acquired by the image-acquisition device shown in FIG. 8. FIG. 11 is a view showing an image to which conversion processing has been applied by the fluorescence-signal processing unit shown in FIG. 8.

The fluorescence-signal processing unit 157 generates an image signal, based on the image-acquisition signal received from the image-acquisition device 43 and the signal indicating the insertion length received from the image sensor 161. The image-acquisition signal received from the image-acquisition device 43 indicates an image of the inner wall of the body cavity 3, reflected at the circumferential face of the conical mirror 135, as shown in FIG. 10. The fluorescence-signal processing unit 157 applies unrolling processing, stretch processing, etc. to the image-acquisition signal based on the signal indicating the insertion length, to generate an image signal indicating an unrolled image of the body cavity 3, as shown in FIG. 11. The generated image signal is output to the monitor 59, as shown in FIG. 8, and displayed on the monitor 59.

According to the above-described structure, excitation light is emitted from the irradiation mirror 33 toward the outside in the radial directions of the insertion portion 105 and irradiates the inner wall of the body cavity 3 that is brought into contact with the balloon 15. Fluorescence is generated at the inner wall of the body cavity 3 irradiated with the excitation light and enters the insertion portion 105. The fluorescence entering the insertion portion 105 is reflected by the conical mirror 135 provided in the light introducing part 119 in the direction of the central axis of the insertion portion 105. The image-acquisition device 43 of the image-acquisition unit 21 acquires an image with the fluorescence reflected by the conical mirror 135. The image-acquisition device 43 can obtain an image of a partial area of the inner wall located in the radial directions of the insertion portion 105.

### Second Modification of First Embodiment

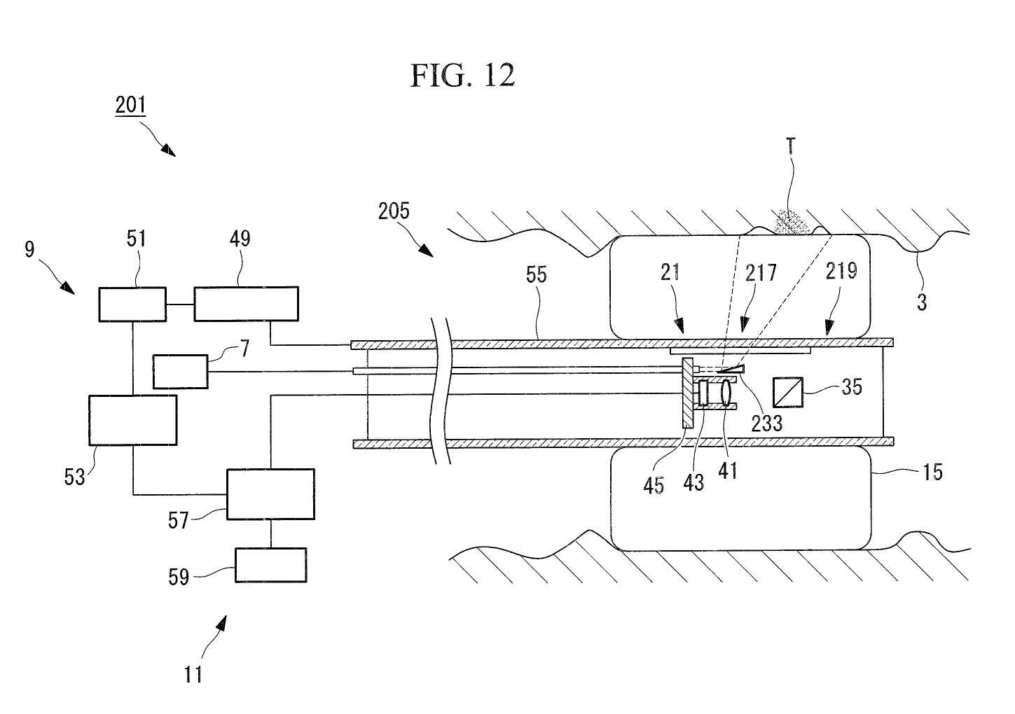

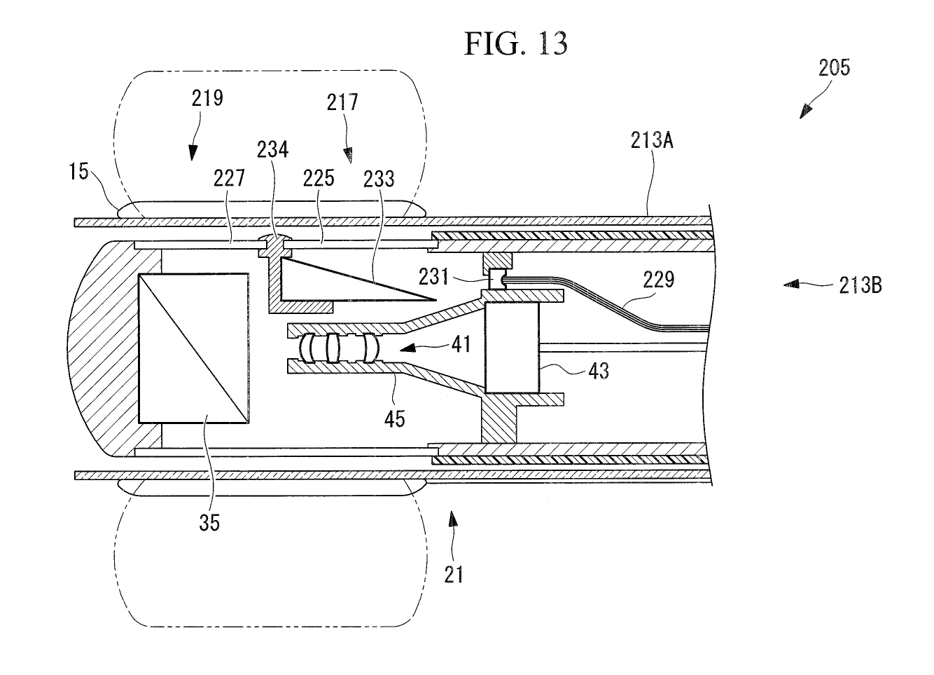

Next, a second modification of the first embodiment of the present invention will be described with reference to FIGS. 12 and 13.

Although the basic structure of a fluorescence endoscope of this modification is the same as that of the first embodiment, the structure of an insertion portion of this modification is different from that of the first embodiment. Therefore, in this modification, only the insertion portion and the components surrounding it will be described with reference to FIGS. 12 and 13, and a description of the other components will be omitted.

FIG. 12 is a view for explaining the structure of the fluorescence endoscope according to this modification.

Note that the same reference symbols are given to the same components as those of the first embodiment, and a description thereof will be omitted.

As shown in FIG. 12, a fluorescence endoscope 201 includes an insertion portion 205 that is to be inserted into the body cavity 3 of a subject, the light source 7 that emits excitation light, the measurement control unit 9 that measures the distance between the insertion portion 205 and the inner wall of the body cavity 3, and the display unit 11 that displays an acquired fluorescence image.

FIG. 13 is a view for explaining the structure of the insertion portion shown in FIG. 13.

As shown in FIG. 12, the insertion portion 205 is provided with an outer insertion portion (insertion portion) 213A and an inner insertion portion (light emitting and introducing unit, rotating unit) 213B.

The outer insertion portion 213A is a tube serving as the outer circumferential face of the insertion portion 205. The balloon 15 is disposed on the outer circumferential face of the insertion end (the left end of FIG. 13) of the outer insertion portion 213A. It is desired that at least an area of the outer insertion portion 213A where the balloon 15 is disposed and that faces an excitation-light window 225 and a fluorescence window 227, to be described later, be made from a material that transmits excitation light passing through the excitation-light window 225 and fluorescence passing through the fluorescence window 227. The outer insertion portion 213A may be formed as an insertion portion of a so-called rigid borescope, which is inflexible. With this structure, the inner insertion portion 213B inserted into the outer insertion portion 213A can be easily rotated with respect to the outer insertion portion 213A.

The inner insertion portion 213B is inserted into the outer insertion portion 213A. The inner insertion portion 213B is provided with the excitation-light window 225, the fluorescence window 227, a light emitting part (light emitting and introducing unit) 217, a light introducing part (light emitting and introducing unit) 219, and the image-acquisition unit 21.

Excitation light passes through the excitation-light window 225 from the inside of the inner insertion portion 213B to the outside thereof. The excitation-light window 225 is formed close to the tip of the inner insertion portion 213B such that the length of the excitation-light window 225 in the circumferential direction of the inner insertion portion 213B is about ¼ of the circumference thereof.

Fluorescence passes through the fluorescence window 227 from the outside of the inner insertion portion 213B to the inside thereof. The fluorescence window 227 is formed close to the tip of the inner insertion portion 213B such that the length of the fluorescence window 227 in the circumferential direction of the inner insertion portion 213B is about ¼ of the circumference thereof. The fluorescence window 227 is formed closer to the tip of the inner insertion portion 213B than the excitation-light window 225.

The lengths of the excitation-light window 225 and the fluorescence window 227 in the circumferential direction may be about ¼ of the circumference, as described above, or may be longer or shorter than that length; the lengths are not particularly limited.

The light emitting part 217 emits excitation light emitted by the light source 7 toward the inner wall of the body cavity 3. As shown in FIG. 13, the light emitting part 217 includes a light guide 229, an irradiation lens 231, and an irradiation mirror (irradiation unit) 233.

The light guide 229 guides excitation light emitted by the light source 7 to the irradiation lens 231 disposed at the insertion end of the inner insertion portion 213B. The light guide 229 is constituted by a bundle of fibers that guide excitation light.

The irradiation lens 231 is used to irradiate the entire observation area of the body cavity 3 with the excitation light. The irradiation lens 231 is disposed at the insertion end of the inner insertion portion 213B between the light guide 229 and the irradiation mirror 233. The irradiation lens 231 has a concave surface that faces the light guide 229.

The irradiation mirror 233 reflects the excitation light emitted in the direction of the central axis of the insertion portion 205 by the irradiation lens 231 toward the outside in radial directions of the inner insertion portion 213B. The irradiation mirror 233 is disposed inside the inner insertion portion 213B at a location facing the excitation-light window 225. The irradiation mirror 233 has a solid shape formed by rotating a cross-sectional triangular shape in a plane that includes the central axis of the inner insertion portion 213B, about the central axis. The irradiation mirror 233 is held by a mirror holding part 234.

The light introducing part 219 reflects fluorescence generated at the body cavity 3 toward the image-acquisition unit 21. As shown in FIG. 13, the light introducing part 219 includes the dichroic mirror (reflecting unit) 35. The dichroic mirror 35 is directly fixed at the tip of the inner insertion portion 213B.

Next, a description will be given of a method of acquiring an image of the inner wall of the body cavity 3, used by the fluorescence endoscope 201 having the above-described structure.

First, the outer insertion portion 213A of the fluorescence endoscope 201 is inserted into the body cavity 3. The insertion into the body cavity may be performed with a direct-view endoscope (not shown) being inserted into the outer insertion portion 213A. The insertion can be easily performed because it is possible to view in the insertion direction. When the outer insertion portion 213A reaches an observation location, the direct-view endoscope is pulled out and the inner insertion portion 213B is inserted. At this time, the balloon 15 is deflated so as not to interfere with the insertion and is in close contact with the outer circumferential face of the outer insertion portion 213A. When the insertion end of the outer insertion portion 213A reaches an area to be examined in the body cavity 3, the air supply pump 49 supplies air to the balloon 15, and the balloon 15 is inflated to press against the inner wall of the body cavity 3. The outer insertion portion 213A is secured to the body cavity 3 with the balloon 15, and the insertion end of the outer insertion portion 213A is positioned approximately at the center of the tract of the body cavity 3.

Then, the inner insertion portion 213B is inserted into the outer insertion portion 213A.

Since the balloon 15 works in the same way as in the first embodiment, a description thereof will be omitted.

Then, the light source 7 emits excitation light. The excitation light is guided by the light guide 229 in the inner insertion portion 213B to the tip of the inner insertion portion 213B. The excitation light is emitted from the light guide 229 in the direction along the central axis of the inner insertion portion 213B and passes through the irradiation lens 231 to be incident on the irradiation mirror 233. The excitation light incident on the irradiation mirror 233 is reflected toward the outside in radial directions of the inner insertion portion 213B and passes through the excitation-light window 225, the outer insertion portion 213A, and the balloon 15 to be incident on the body cavity 3. The excitation light passes through the irradiation lens 231, thereby illuminating the entire face of the observation area of the body cavity 3.

The body cavity 3 on which the excitation light was incident generates fluorescence. In particular, the lesion T generates a larger amount of fluorescence than a normal part of the body cavity 3. The fluorescence passes through the balloon 15, the outer insertion portion 213A, and the fluorescence window 227 to enter the inner insertion portion 213B. Of the entering fluorescence, fluorescence incident on the dichroic mirror 35 is reflected in the direction of the central axis of the inner insertion portion 213B. Light having wavelengths other than that of the fluorescence incident on the dichroic mirror 35 passes through the dichroic mirror 35 without being reflected.

The image-acquisition lens system 41 forms an image with the fluorescence reflected by the dichroic mirror 35 on the light receiving surface of the image-acquisition device 43. Based on the formed fluorescence image, the image-acquisition device 43 outputs an image-acquisition signal to the fluorescence-signal processing unit 57.

The fluorescence-signal processing unit 57 generates an image signal based on the image-acquisition signal received from the image-acquisition device 43. The image signal is output from the fluorescence-signal processing unit 57 to the monitor 59 and is displayed on the monitor 59.

Since the inner insertion portion 213B is disposed so as to be rotatable about the central axis with respect to the outer insertion portion 213A, when the inner insertion portion 213B is rotated, fluorescence generated at a predetermined part of the inner wall of the body cavity 3 can be observed.

According to the above-described structure, excitation light is emitted from the irradiation mirror 233 provided in the inner insertion portion 213B outward in radial directions of the insertion portion 205 to irradiate the inner wall of the body cavity that is brought into contact with the balloon 15. The inner wall of the body cavity irradiated with the excitation light generates fluorescence. The fluorescence passes through the insertion portion 205 to enter the inner insertion portion 213B. The fluorescence entering the inner insertion portion 213B is reflected in the direction of the central axis of the insertion portion 205 by the dichroic mirror 35 provided in the inner insertion portion 213B. The image-acquisition device 43 of the image-acquisition unit 21 acquires an image with the fluorescence reflected by the dichroic mirror 35. The image-acquisition device 43 can obtain the image of a partial area of the inner wall located in the radial directions of the insertion portion 205.

Since the inner insertion portion 213B is disposed inside the insertion portion 205 so as to be rotatable about the central axis of the insertion portion 205, the fluorescence can enter the insertion portion 205 from a plurality of different radial directions of the insertion portion 205. Therefore, the image-acquisition device 43 can acquire an image with the fluorescence generated at the inner wall of the body cavity located in the plurality of different radial directions of the insertion portion 205.

### Third Modification of First Embodiment

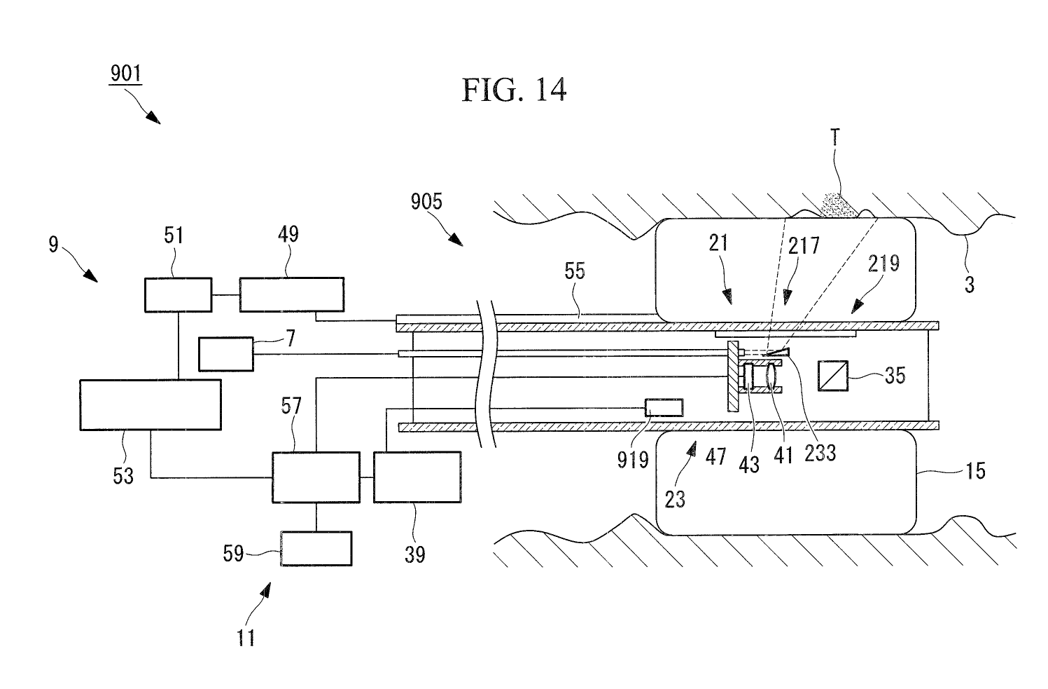

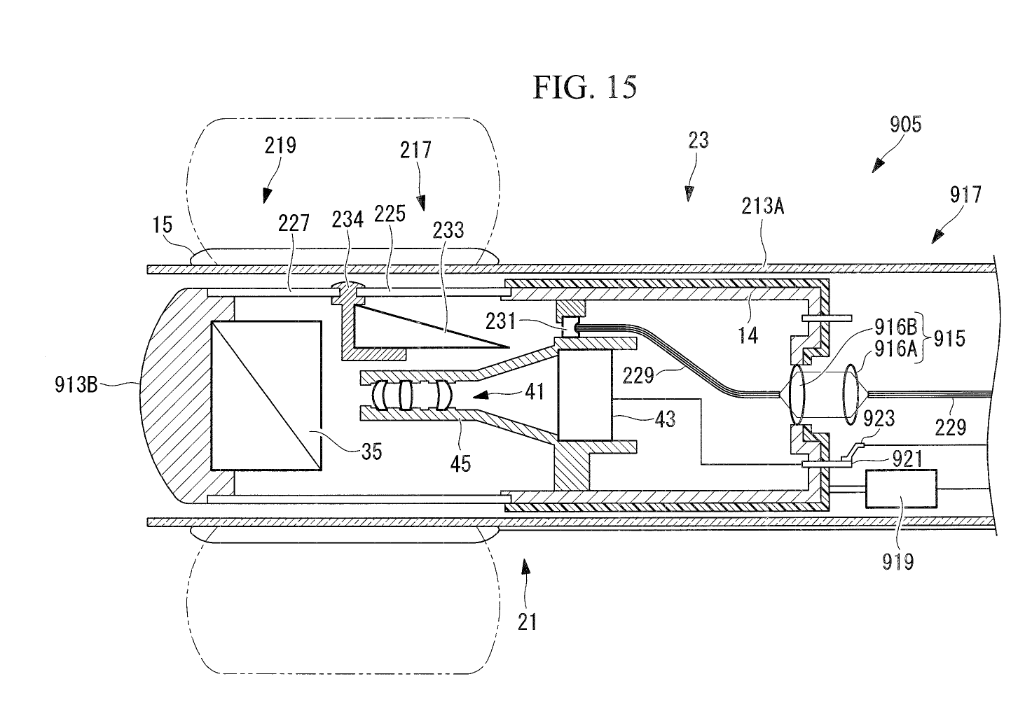

Next, a third modification of the first embodiment of the present invention will be described with reference to FIGS. 14 and 15.

Although the basic structure of a fluorescence endoscope of this modification is the same as that of the second modification of the first embodiment, the structure of a rotary insertion portion of this modification is different from that of the first embodiment. Therefore, in this modification, only the rotary insertion portion and the components surrounding it will be described with reference to FIGS. 14 and 15, and a description of the other components will be omitted.

FIG. 14 is a view for explaining the structure of the fluorescence endoscope according to this modification.

Note that the same reference symbols are given to the same components as those of the second modification of the first embodiment, and a description thereof will be omitted.

As shown in FIG. 14, a fluorescence endoscope 901 includes an insertion portion 905 that is to be inserted into the body cavity 3 of a subject, the light source 7 that emits excitation light, the measurement control unit 9 that measures the distance between the insertion portion 905 and the inner wall of the body cavity 3, and the display unit 11 that displays an acquired fluorescence image.

FIG. 15 is a view for explaining the structure of the insertion portion shown in FIG. 14.

As shown in FIG. 15, the insertion portion 905 includes the outer insertion portion 213A and a rotary insertion portion (light emitting and introducing unit, rotating unit) 913B.

The rotary insertion portion 913B is disposed inside the tip of the outer insertion portion 213A so as to be rotatable about the central axis of the insertion portion 905. The rotary insertion portion 913B is provided with the excitation-light window 225, the fluorescence window 227, the light emitting part 217, the light introducing part 219, and the image-acquisition unit 21. Further, the rotary insertion portion 913B is provided with a light rotary joint 915, a signal rotary joint 917, and an insertion-portion drive motor 919.

The light rotary joint 915 guides excitation light from the outer insertion portion 213A to the rotary insertion portion 913B rotated in the outer insertion portion 213A. The light rotary joint 915 is disposed on the central axis of the insertion portion 905 so as to link the light guide 229 in the outer insertion portion 213A to the light guide 229 in the rotary insertion portion 913B. The light rotary joint 915 includes lenses 916A and 916B disposed facing each other. The lens 916A is disposed in the outer insertion portion 213A. The lens 916B is disposed in the rotary insertion portion 913B. Therefore, excitation light emitted from the light guide 229 in the outer insertion portion 213A passes through the lenses 916A and 916B to be incident on the light guide 229 in the rotary insertion portion 913B.

Note that, in this embodiment, any known light rotary joint can be used as the light rotary joint 915; the light rotary joint 915 is not limited to the light rotary joint shown as an example in this embodiment.

The signal rotary joint 917 electrically connects the outer insertion portion 213A to the rotary insertion portion 913B rotated in the outer insertion portion 213A. The signal rotary joint 917 includes an image-acquisition collector ring 921 and an image-acquisition brush 923 that guide an image-acquisition signal output from the image-acquisition device 43 to the fluorescence-signal processing unit 57.

The image-acquisition collector ring 921 is a member having a circular ring shape or a cylindrical shape provided for the rotary insertion portion 913B. The collector ring 921 is disposed such that the central axis thereof is aligned with the central axis of the rotary insertion portion 913B. The image-acquisition collector ring 921 is electrically connected to the image-acquisition device 43.

The image-acquisition brush 923 is provided in the outer insertion portion 213A. The image-acquisition brush 923 is slidably disposed on the circumferential face or the cylindrical face of the image-acquisition collector ring 921 and is electrically connected to the fluorescence-signal processing unit 57.

Note that, in this embodiment, any known collector, such as a slip ring, can be used as the signal rotary joint 917; the signal rotary joint 917 is not limited to the signal rotary joint shown as an example in this embodiment.

The insertion-portion drive motor 919 is disposed in the outer insertion portion 213A and rotates the rotary insertion portion 913B in the outer insertion portion 213A. The insertion-portion drive motor 919 is disposed to rotationally drive the rotary insertion portion 913B via a gear (not shown) or the like and is connected to the motor control unit 39.

Note that any known motor can be used as the insertion-portion drive motor 919; the insertion-portion drive motor 919 is not particularly limited.

Next, a description will be given of a method of acquiring an image of the inner wall of the body cavity 3, used by the fluorescence endoscope 901 having the above-described structure.

Note that since a method of securing the insertion portion 905 with the balloon 15 and a method of controlling the distance from the inner wall of the body cavity 3 to the image-acquisition device 43 are the same as those of the first embodiment, a description thereof will be omitted.

The function of the light rotary joint 915, which is a feature of this modification, will be described.

Excitation light emitted by the light source 7 is guided by the light guide 229 in the outer insertion portion 213A to the light rotary joint 915. The excitation light is emitted from the light guide 229 in the outer insertion portion 213A toward the lens 916A. The excitation light incident on the lens 916A becomes collimated and is incident on the lens 916B.

Since the optical axes of the lenses 916A and 916B are aligned with the central axis of the rotary insertion portion 913B, even when the rotary insertion portion 913B is rotationally driven by the insertion-portion drive motor 919, the excitation light emitted from the lens 916A is entirely incident on the lens 916B rotated together with the rotary insertion portion 913B.

The excitation light incident on the lens 916B is focused on the light guide 229 in the rotary insertion portion 913B. The focused excitation light is emitted through the irradiation lens 231. Since the excitation light illuminates the body cavity 3 in the same way as in the second modification, a description thereof will be omitted.

Next, the function of the signal rotary joint 917, which is another feature of this modification, will be described. Note that since an image is formed on the image-acquisition device 43 with fluorescence generated at the body cavity 3 in the same way as in the second modification, a description thereof will be omitted.

Based on the formed fluorescence image, the image-acquisition device 43 outputs an image-acquisition signal to the signal rotary joint 917. The image-acquisition signal output from the image-acquisition device 43 passes through the image-acquisition collector ring 921 and the image-acquisition brush 923 of the signal rotary joint 917 to be input to the fluorescence-signal processing unit 57.

Since the central axis of the image-acquisition collector ring 921 is aligned with the central axis of the rotary insertion portion 913B, even when the rotary insertion portion 913B is rotationally driven by the insertion-portion drive motor 919, the image-acquisition collector ring 921 and the image-acquisition brush 923 can be kept in sliding contact without moving apart from each other. Therefore, the image-acquisition collector ring 921 and the image-acquisition brush 923 can maintain the electrical connection.

According to the above-described structure, excitation light is emitted from the light emitting part 217 provided in the rotary insertion portion 913B outward in radial directions of the insertion portion 905 to irradiate the inner wall of the body cavity 3 that is brought into contact with the balloon 15. The inner wall of the body cavity 3 irradiated with the excitation light generates fluorescence. The fluorescence passes through the outer insertion portion 213A to enter the rotary insertion portion 913B. The image-acquisition device 43 provided in the rotary insertion portion 913B acquires an image with the fluorescence entering the rotary insertion portion 913B.

Since the rotary insertion portion 913B is disposed inside the outer insertion portion 213A so as to be rotatable about the central axis of the insertion portion 905, it is possible to introduce fluorescence to the inside of the rotary insertion portion 913B from a plurality of different radial directions of the insertion portion 905.

### Fourth Modification of First Embodiment

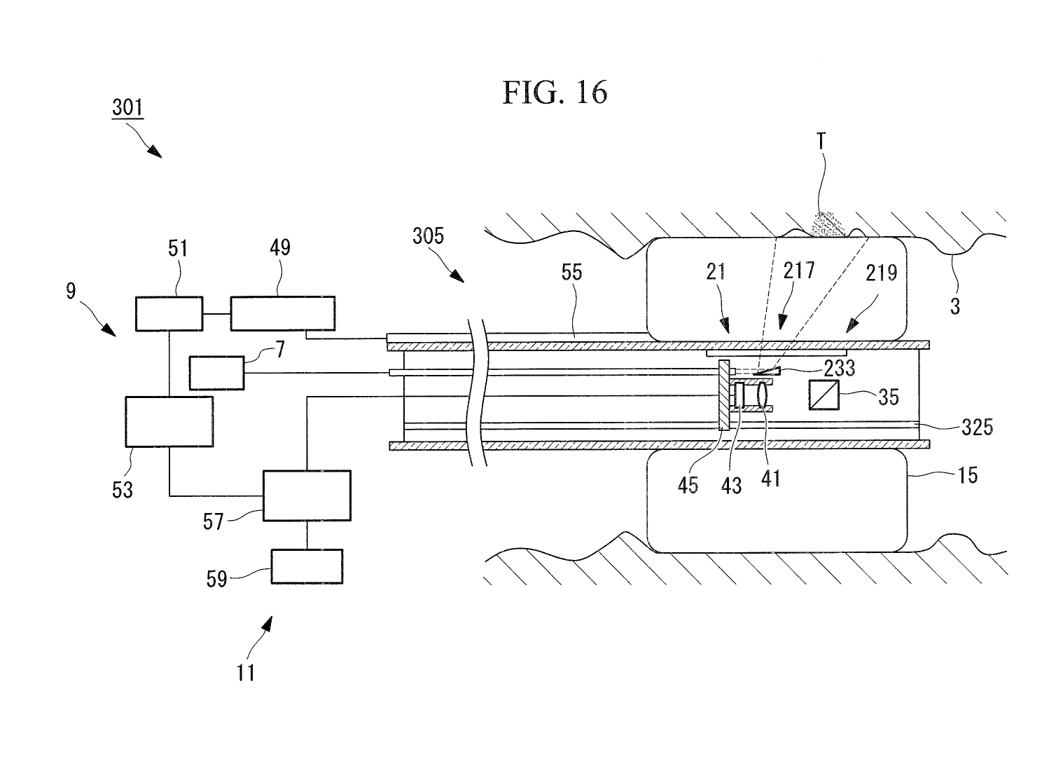

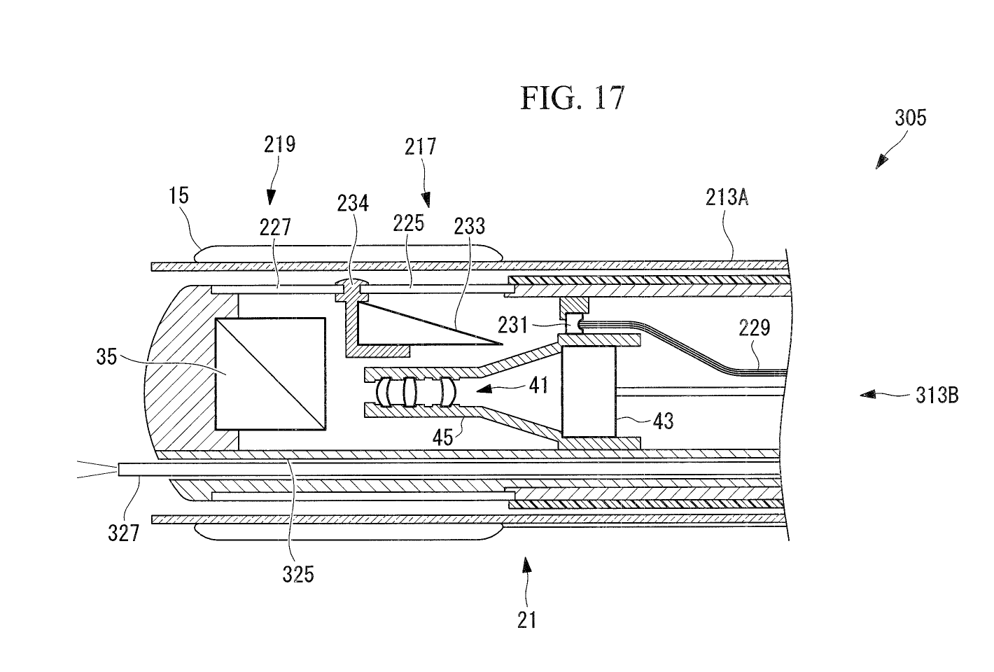

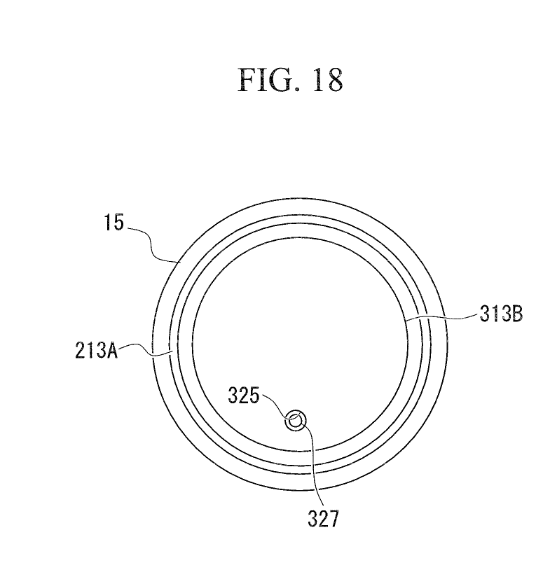

Next, a fourth modification of the first embodiment of the present invention will be described with reference to FIGS. 16 to 18.

Although the basic structure of a fluorescence endoscope of this modification is the same as that of the second modification of the first embodiment, the structure of an inner insertion portion of this modification is different from that of the first embodiment. Therefore, in this modification, only the inner insertion portion and the components surrounding it will be described with reference to FIGS. 16 to 18, and a description of the other components will be omitted.

FIG. 16 is a view for explaining the structure of the fluorescence endoscope according to this modification.

Note that the same reference symbols are given to the same components as those of the second modification of the first embodiment, and a description thereof will be omitted.

As shown in FIG. 16, a fluorescence endoscope 301 includes an insertion portion 305 that is to be inserted into the body cavity 3 of a subject, the light source 7 that emits excitation light, the measurement control unit 9 that measures the distance between the insertion portion 305 and the inner wall of the body cavity 3, and the display unit 11 that displays an acquired fluorescence image.

FIG. 17 is a view for explaining the structure of the insertion portion shown in FIG. 16.

As shown in FIG. 17, the insertion portion 305 includes the outer insertion portion 213A and an inner insertion portion (light emitting and introducing unit, rotating unit) 313B.

FIG. 18 is a front view for explaining the structure of the insertion portion shown in FIG. 17.

The inner insertion portion 313B is inserted into the outer insertion portion 213A. The inner insertion portion 313B is provided with the excitation-light window 225, the fluorescence window 227, the light emitting part (light emitting and introducing unit) 217, the light introducing part (light emitting and introducing unit) 219, the image-acquisition unit 21, and a forceps hole 325.

The forceps hole 325 is a through-hole that is provided in the inner insertion portion 313B and into which a direct-view scope 327, a pair of forceps, or the like is inserted. The forceps hole 325 is formed close to the outer circumferential face of the inner insertion portion 313B (see FIG. 18), along the central axis.

Next, a description will be given of a method of acquiring an image of the inner wall of the body cavity 3, used by the fluorescence endoscope 301 having the above-described structure.

Note that since a method of securing the outer insertion portion 213A with the balloon 15 and a method used by the inner insertion portion 313B to acquire a fluorescence image of the body cavity 3 are the same as in the second modification of the first embodiment, a description thereof will be omitted.

Next, how to use the forceps hole 325 of the inner insertion portion 313B will be described.

For example, the direct-view scope 327 is inserted into the forceps hole 325 such that the tip of the direct-view scope 327 protrudes from the tip of the inner insertion portion 313B. In this way, with the use of the direct-view scope 327, an image in the direction of the central axis of the insertion portion 305 can be obtained.

Alternatively, various types of forceps can be inserted into the forceps hole 325 to perform corresponding medical procedures in the body cavity 3.

### Fifth Modification of First Embodiment

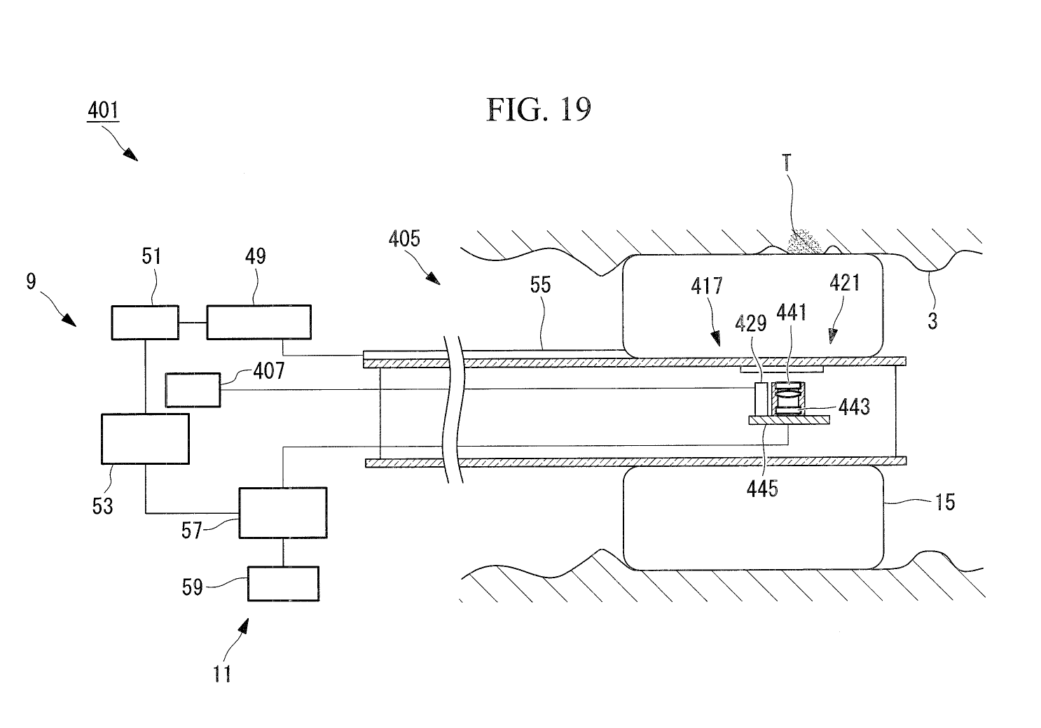

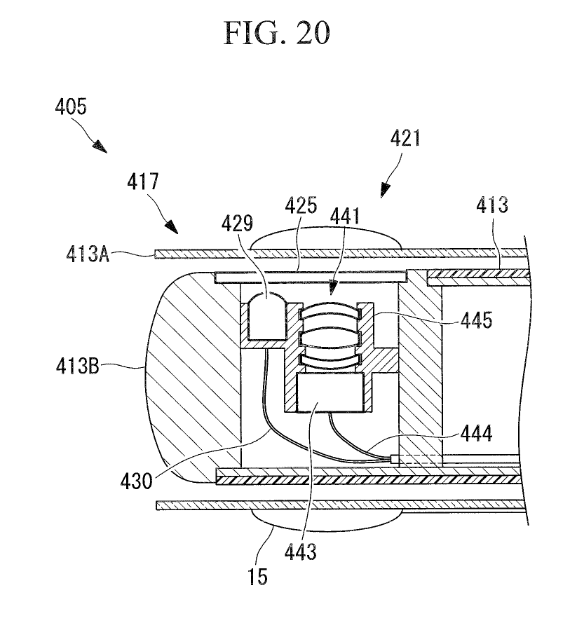

Next, a fifth modification of the first embodiment of the present invention will be described with reference to FIGS. 19 and 20.

Although the basic structure of a fluorescence endoscope of this modification is the same as that of the first embodiment, the structure of an insertion portion of this modification is different from that of the first embodiment. Therefore, in this modification, only the insertion portion and the components surrounding it will be described with reference to FIGS. 19 and 20, and a description of the other components will be omitted.

FIG. 19 is a view for explaining the structure of the fluorescence endoscope according to this modification.

Note that the same reference symbols are given to the same components as those of the first embodiment, and a description thereof will be omitted.

As shown in FIG. 19, a fluorescence endoscope 401 includes an insertion portion 405 that is to be inserted into the body cavity 3 of a subject, a power source 407 that supplies power, the measurement control unit 9 that measures the distance between the insertion portion 405 and the inner wall of the body cavity 3, and the display unit 11 that displays an acquired fluorescence image.

FIG. 20 is a view for explaining the structure of the insertion portion shown in FIG. 19.

As shown in FIG. 20, the insertion portion 405 is provided with an outer insertion portion 413A and an inner insertion portion (light emitting and introducing unit, rotating unit) 413B.

The outer insertion portion 413A is a tube serving as the outer circumferential face of the insertion portion 405. The balloon 15 is disposed on the outer circumferential face of the insertion end (the left end of FIG. 20) of the outer insertion portion 413A. At least an area of the outer insertion portion 413A where the balloon 15 is disposed and that faces a window 425, to be described later, may be made from a material that transmits excitation light and fluorescence that pass through the window 425. It is desired that the outer insertion portion 413A be formed as an insertion portion of a so-called rigid borescope, which is inflexible. With this structure, the inner insertion portion 413B inserted into the outer insertion portion 413A can be easily rotated with respect to the outer insertion portion 413A.

The inner insertion portion 413B is inserted into the outer insertion portion 413A. As shown in FIG. 20, the inner insertion portion 413B is provided with a casing tube 413, a light emitting part (light emitting and introducing unit) 417, an image-acquisition unit 421, and the window 425 through which excitation light and fluorescence pass.

The casing tube 413 serves as the outer circumferential face of the inner insertion portion 413B. The window 425, through which excitation light and fluorescence pass, is provided at the insertion end (the left end of FIG. 20) of the casing tube 413. The balloon 15 is disposed on the outer circumferential face of the window 425. The light emitting part 417, the image-acquisition unit 421, and a holding part 445 are disposed in the casing tube 413. The window 425 is made from a material that transmits excitation light emitted by the light source 7 and fluorescence generated at the body cavity 3.

The light emitting part 417 emits the excitation light toward the inner wall of the body cavity 3. The light emitting part 417 includes an LED (light emitting diode) (irradiation unit) 429, as shown in FIG. 20.

The LED 429 is supplied with power from the power source 407, thereby emitting excitation light. The LED 429 is disposed at an outer location in a radial direction of the insertion portion 405 so as to emit excitation light toward the window 425. The LED 429 and the power source 407 are connected by a power line 430. Note that, as the light emitting part 417, the LED 429 may be used as described above or another device that emits excitation light may be used; the light emitting part 417 is not particularly limited.

The image-acquisition unit 421 acquires an image with fluorescence generated at the body cavity 3. As shown in FIG. 20, the image-acquisition unit 421 includes an image-acquisition lens system 441 and an image-acquisition device 443.

The image-acquisition lens system 441 forms an image with fluorescence that has passed through the window 425 on the light receiving surface of the image-acquisition device 443. The image-acquisition lens system 441 is disposed between the window 425 and the image-acquisition device 443. The image-acquisition lens system 441 is disposed such that the optical axis thereof is parallel to a radial direction of the inner insertion portion 413B.

The image-acquisition device 443 acquires an image with fluorescence generated at the body cavity 3. The image-acquisition device 443 is disposed so as to be able to acquire an image with fluorescence entering through the window 425. In other words, the image-acquisition device 443 is disposed so as to be able to acquire an image with fluorescence entering from the outside in the radial directions of the inner insertion portion 413B. The image-acquisition device 443 is connected to the fluorescence-signal processing unit 57 of the display unit 11 by a signal line 444.

The holding part 445 holds the LED 429 and the image-acquisition device 443.

Next, a description will be given of a method of acquiring an image of the inner wall of the body cavity 3, used by the fluorescence endoscope 401 having the above-described structure.

First, the outer insertion portion 413A of the fluorescence endoscope 401 is inserted into the body cavity 3. The insertion into the body cavity may be performed with a direct-view endoscope (not shown) being inserted into the outer insertion portion 413A. The insertion can be easily performed because it is possible to view in the insertion direction. When the outer insertion portion 413A reaches an observation location, the direct-view endoscope is pulled out and the inner insertion portion 413B is inserted. At this time, the balloon 15 is deflated so as not to interfere with the insertion and is in close contact with the outer circumferential face of the outer insertion portion 413A. When the insertion end of the outer insertion portion 413A reaches an area to be examined in the body cavity 3, the air supply pump 49 supplies air to the balloon 15, and the balloon 15 is inflated to press against the inner wall of the body cavity 3. The outer insertion portion 413A is secured to the body cavity 3 with the balloon 15, and the insertion end of the outer insertion portion 413A is positioned approximately at the center of the tract of the body cavity 3.

Then, the inner insertion portion 413B is inserted into the outer insertion portion 413A.

Note that since a method of securing the outer insertion portion 413A with the balloon 15 and a method of measuring the distance from the inner wall of the body cavity 3 to the image-acquisition device 443 are the same as those of the first embodiment, a description thereof will be omitted.

Then, the power source 407 supplies power to the LED 429, and the LED 429 emits excitation light. The excitation light is emitted toward the outside in radial directions of the inner insertion portion 413B and passes through the window 425 and the balloon 15 to be incident on the body cavity 3.

The body cavity 3 on which the excitation light is incident generates fluorescence. The fluorescence passes through the balloon 15 and the window 425 to enter the inner insertion portion 413B. The image-acquisition lens system 441 forms an image with the entering fluorescence on the light receiving surface of the image-acquisition device 443. The image-acquisition device 443 outputs an image-acquisition signal to the fluorescence-signal processing unit 57 based on the formed fluorescence image.

Since the signal processing performed by the fluorescence-signal processing unit 57 and the subsequent processing are the same as those of the first embodiment, a description thereof will be omitted.

According to the above-described structure, the LED 429 provided in the inner insertion portion 413B can emit excitation light outward in radial directions of the insertion portion 405. Thus, the excitation light irradiates the inner wall of the body cavity 3 that is brought into contact with the balloon 15, and the inner wall of the body cavity 3 irradiated with the excitation light generates fluorescence. The generated fluorescence passes through the insertion portion 405 to enter the inner insertion portion 413B. The image-acquisition device 443 provided in the inner insertion portion 413B can acquire an image with the fluorescence entering the inner insertion portion 413B.

Since the inner insertion portion 413B is disposed inside the insertion portion 405 so as to be rotatable about the central axis, it is possible to introduce fluorescence to the inside of the insertion portion 405 from a plurality of different radial directions of the insertion portion 405. Therefore, the image-acquisition device 443 of the image-acquisition unit 421 can acquire an image with fluorescence generated at the inner wall of the body cavity 3 located in a plurality of different radial directions of the insertion portion 405.

### Sixth Modification of First Embodiment

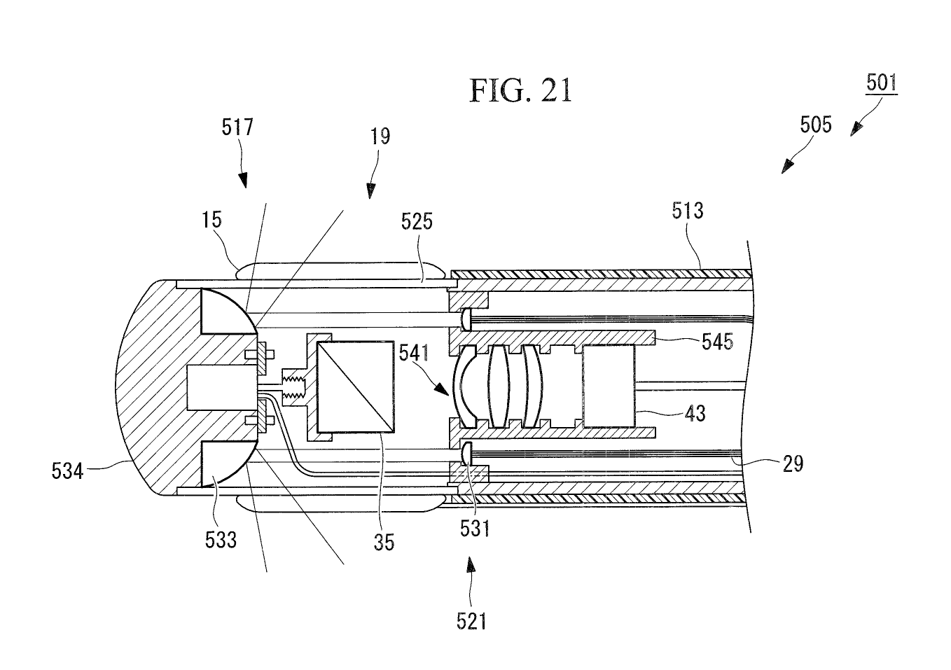

Next, a sixth modification of the first embodiment of the present invention will be described with reference to FIG. 21.

Although the basic structure of a fluorescence endoscope of this modification is the same as that of the first embodiment, the structure of an insertion portion of this modification is different from that of the first embodiment. Therefore, in this modification, only the insertion portion and the components surrounding it will be described with reference to FIG. 21, and a description of the other components will be omitted.

FIG. 21 is a view for explaining the structure of the fluorescence endoscope according to this modification.

Note that the same reference symbols are given to the same components as those of the first embodiment, and a description thereof will be omitted.

As shown in FIG. 21, a fluorescence endoscope 501 includes an insertion portion 505 that is to be inserted into the body cavity 3 of a subject, the light source 7 that emits excitation light, the measurement control unit 9 that measures the distance between the insertion portion 505 and the inner wall of the body cavity 3, and the display unit 11 that displays an acquired fluorescence image.

The insertion portion 505 is inserted into the body cavity 3 of the subject and observes fluorescence generated at the inner wall of the body cavity 3. As shown in FIG. 21, the insertion portion 505 includes a casing tube 513, the balloon 15, a light emitting part (light emitting and introducing unit) 517, the light introducing part (light emitting and introducing unit) 19, and an image-acquisition unit 521.

The casing tube 513 serves as the outer circumferential face of the insertion portion 505. A window 525 that transmits excitation light and fluorescence is provided at the insertion end (the left end of FIG. 21) of the casing tube 513. The balloon 15 is disposed on the outer circumferential face of the window 525. The light emitting part 517, the image-acquisition unit 521, and a holding part 545 are disposed in the casing tube 513. The window 525 is formed in a cylindrical shape and is made from a material that transmits excitation light emitted by the light source 7 and fluorescence generated at the body cavity 3.

The light emitting part 517 emits excitation light emitted by the light source 7 (see FIG. 1) toward the inner wall of the body cavity 3. As shown in FIG. 21, the light emitting part 517 includes the light guide 29, an irradiation lens 531, an irradiation mirror (irradiation unit) 533.

The irradiation lens 531 is used to irradiate the entire observation area of the body cavity 3 with the excitation light. The irradiation lens 531 is disposed at the insertion end of the insertion portion 505 between the light guide 29 and the irradiation mirror 533. The irradiation lens 531 is formed in a circular ring shape with its convex surface facing the irradiation mirror 533.

The irradiation mirror 533 reflects the excitation light emitted in the direction of the central axis of the insertion portion 505 from the irradiation lens 531 toward the outside in the radial directions of the insertion portion 505. The irradiation mirror 533 is disposed inside the insertion portion 505 at a location facing the window 525. The irradiation mirror 533 is formed such that it has an approximately conical shape with its conical surface being used as a reflecting surface and has a through-hole along the central axis. As shown in the figure, the conical surface is curved outward in a convex manner. The irradiation mirror 533 has a solid shape formed by rotating a cross-sectional triangular shape in a plane that includes the central axis of the insertion portion 505, about the central axis. The irradiation mirror 533 is held by a tip part 534 of the insertion portion 505.

The image-acquisition unit 521 acquires an image with fluorescence generated at the body cavity 3. As shown in FIG. 21, the image-acquisition unit 521 includes an image-acquisition lens system 541 and the image-acquisition device 43.

The image-acquisition lens system 541 forms an image with fluorescence reflected by the dichroic mirror 35 on the light receiving surface of the image-acquisition device 43. The image-acquisition lens system 541 is disposed between the dichroic mirror 35 and the image-acquisition device 43.

The holding part 545 holds the irradiation lens 531, the image-acquisition lens system 541, and the image-acquisition device 43.

Next, a description will be given of a method of acquiring an image of the inner wall of the body cavity 3, used by the fluorescence endoscope 501 having the above-described structure.

Note that since a method of securing the insertion portion 505 with the balloon 15 is the same as that of the first embodiment, a description thereof will be omitted.

The light source 7 emits excitation light. The excitation light is guided by the light guide 29 in the insertion portion 505 to the tip of the insertion portion 5. The excitation light is emitted from the light guide 29 in the direction along the central axis of the insertion portion 505 and passes through the irradiation lens 531 to be incident on the irradiation mirror 533. The excitation light is emitted from the irradiation lens 531 as collimated light. The excitation light incident on the irradiation mirror 533 is reflected toward the outside in the radial directions of the insertion portion 505 and passes through the window 525 and the balloon 15 to be incident on the body cavity 3. Note that since the reflecting surface of the irradiation mirror 533 has a convex curved face, the entire face of an observation area in the body cavity 3 can be illuminated with the excitation light.

The subsequent operations and effects are the same as those of the first embodiment, and therefore a description thereof will be omitted.

According to the above-described structure, the diameters of lenses in the image-acquisition lens system 541, which forms an image with fluorescence on the image-acquisition device 43, can be made larger compared with the first embodiment, to increase the intensity of fluorescence used to form the image on the image-acquisition device 43. In other words, it is possible to acquire a brighter fluorescence image compared with the first embodiment.

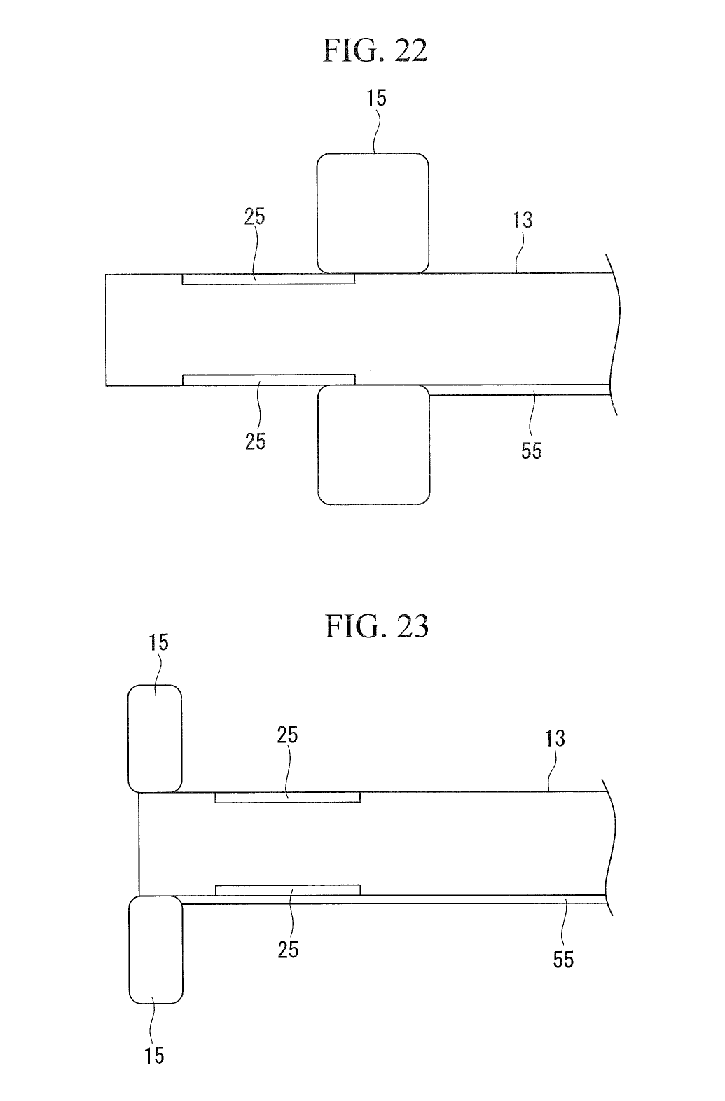

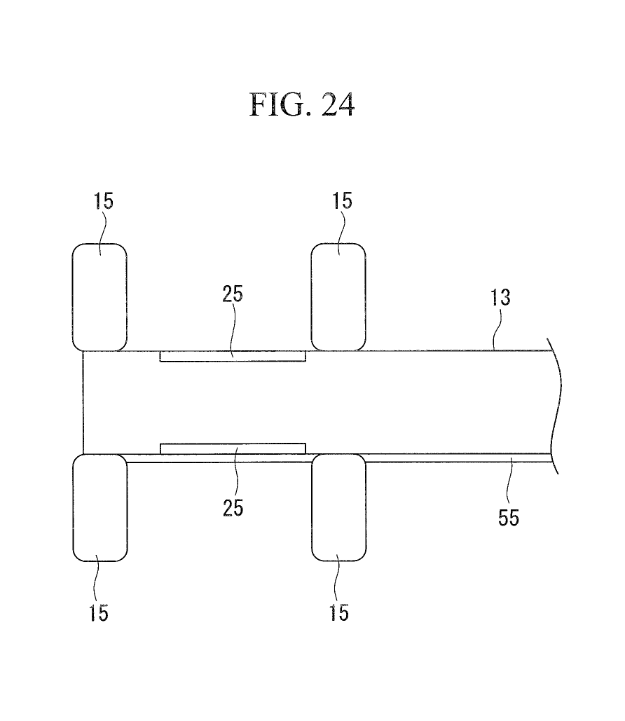

FIG. 22 is a view for explaining another structure for the fluorescence endoscopes shown in FIGS. 1 to 21. FIG. 23 is a view for explaining still another structure for the fluorescence endoscopes shown in FIGS. 1 to 21. FIG. 24 is a view for explaining still another structure for the fluorescence endoscopes shown in FIGS. 1 to 21.

Note that, as described above in the first embodiment and the modifications of the first embodiment, structures in which an observation area is irradiated with excitation light through the balloon 15, and fluorescence generated at the observation area is observed through the balloon 15 may be used. Alternatively, as shown in FIGS. 22 to 24, structures in which an observation area is irradiated with excitation light without using the balloon 15, and fluorescence generated at the observation area is observed without using the balloon 15 may be used. The irradiation and observation method is not particularly limited.

With those structures, the loss of fluorescence when it passes through the balloon 15 is avoided, unlike the method of observing fluorescence through the balloon 15. Therefore, the detected fluorescence intensity can be increased.

Further, for example, in a case where the inner wall of a hollow organ having no folds on the inner wall is observed, even when the location of the balloon 15 does not match the location of an observation area, a large difference does not occur between the measurement distance and the observation distance, causing no problem in the observation.

Specifically, in a fluorescence endoscope shown in FIG. 22, the balloon 15 is disposed closer to the operator's hand than an observation window 25, thereby making excitation light irradiate an observation area without using the balloon 15 and observing fluorescence generated at the observation area without using the balloon 15. In a fluorescence endoscope shown in FIG. 23, the balloon 15 is disposed closer to the tip than the observation window 25, thereby making excitation light irradiate an observation area without using the balloon 15 and observing fluorescence generated at the observation area without using the balloon 15. In a fluorescence endoscope shown in FIG. 24, the balloons 15 are disposed closer to the operator's hand and closer to the tip than the observation window 25, thereby making excitation light irradiate an observation area without using the balloon 15 and observing fluorescence generated at the observation area without using the balloon 15.

### Second Embodiment

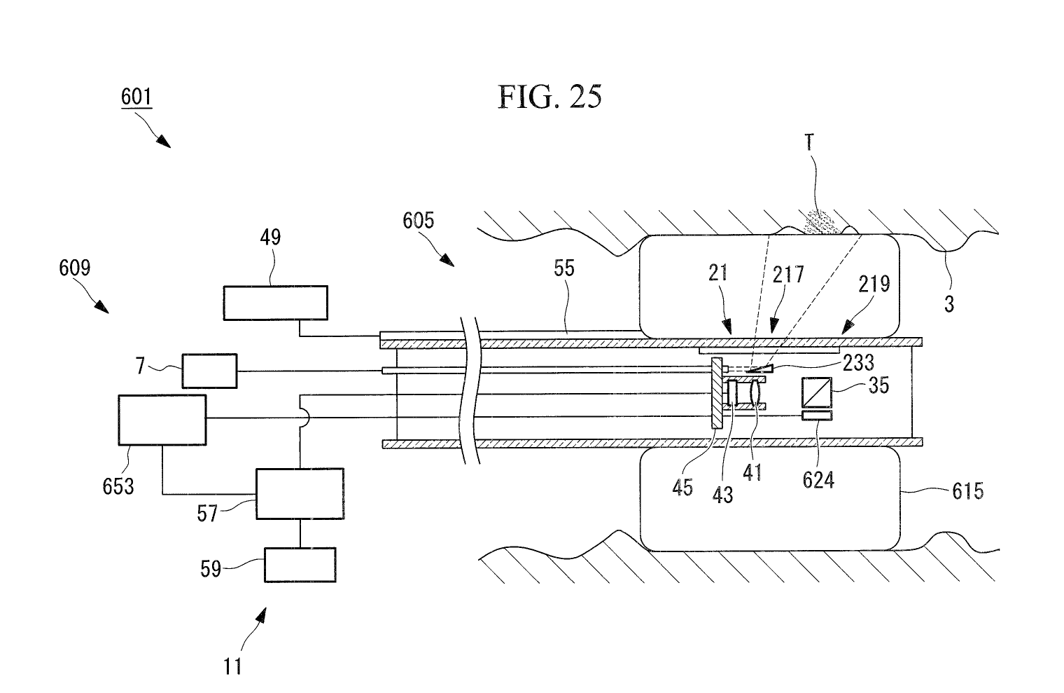

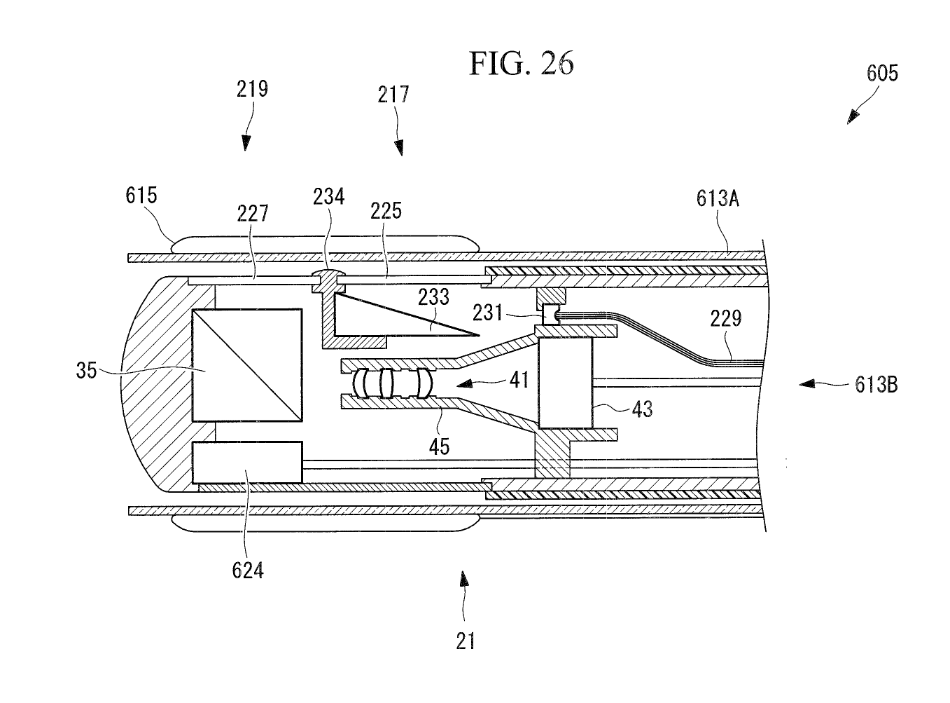

Next, a second embodiment of the present invention will be described with reference to FIGS. 25 and 26.

Although the basic structure of a fluorescence endoscope of this embodiment is the same as that of the second modification of the first embodiment, the structure of an insertion portion of this embodiment is different from that of the second modification of the first embodiment. Therefore, in this embodiment, only the insertion portion and the components surrounding it will be described with reference to FIGS. 25 and 26, and a description of the other components will be omitted.

FIG. 25 is a view for explaining the structure of the fluorescence endoscope according to this embodiment.

Note that the same reference symbols are given to the same components as those of the second modification of the first embodiment, and a description thereof will be omitted.

As shown in FIG. 25, a fluorescence endoscope 601 includes an insertion portion 605 that is to be inserted into the body cavity 3 of a subject, the light source 7 that emits excitation light, a measurement control unit 609 that measures the distance between the insertion portion 605 and the inner wall of the body cavity 3, and the display unit 11 that displays an acquired fluorescence image.

FIG. 26 is a view for explaining the structure of the insertion portion shown in FIG. 25.

As shown in FIG. 25, the insertion portion 605 is provided with an outer insertion portion (insertion portion) 613A and an inner insertion portion (light emitting and introducing unit, rotating unit) 613B.

The outer insertion portion 613A is a tube serving as the outer circumferential face of the insertion portion 605. A balloon 615 is disposed on the outer circumferential face of the insertion end (the left end of FIG. 26) of the outer insertion portion 613A. It is desired that at least an area of the outer insertion portion 613A where the balloon 615 is disposed and that faces the excitation-light window 225 and the fluorescence window 227, to be described later, be made from a material that transmits excitation light passing through the excitation-light window 225 and fluorescence passing through the fluorescence window 227.

A fluorescence agent that generates fluorescence is disposed on the outer circumferential face of the balloon 615 that is brought into contact with the body cavity 3. The fluorescence agent generates fluorescence when irradiated with excitation light emitted by the light source 7. The fluorescence generated at the fluorescence agent has a wavelength that is different from that generated at the body cavity 3 and that is not reflected by the dichroic mirror 35. The fluorescence agent may be applied to the balloon 615 or may be included as a part of membrane components constituting the balloon 615; the way the balloon 615 is provided with the fluorescence agent is not particularly limited.

The inner insertion portion 613B is inserted into the outer insertion portion 613A. As shown in FIG. 26, the inner insertion portion 613B is provided with the excitation-light window 225, the fluorescence window 227, the light emitting part (light emitting and introducing unit) 217, the light introducing part (light emitting and introducing unit) 219, the image-acquisition unit 21, and a fluorescence detecting unit 624.

The fluorescence detecting unit 624 detects the fluorescence intensity of fluorescence generated at the fluorescence agent disposed on the balloon 615. The fluorescence detecting unit 624 is disposed at a location facing the fluorescence window 227 such that the dichroic mirror 35 is sandwiched between the fluorescence detecting unit 624 and the fluorescence window 227. A signal indicating the fluorescence intensity detected by the fluorescence detecting unit 624 is output to a distance measuring unit 653, as shown in FIG. 25.

The measurement control unit 609 measures the distance between the insertion portion 605 and the inner wall of the body cavity 3. As shown in FIG. 25, the measurement control unit 609 includes the air supply pump 49 and the distance measuring unit (calculation unit) 653.

The distance measuring unit 653 measures the distance between the insertion portion 605 and the inner wall of the body cavity 3 and also controls the distance between the image-acquisition device 43 and the inner wall of the body cavity 3 at the predetermined constant distance. The distance measuring unit 653 receives the signal indicating the fluorescence intensity from the fluorescence detecting unit 624. The distance measuring unit 653 can calculate the distance between the insertion portion 605 and the inner wall of the body cavity 3 based on the signal and output a distance signal indicating the distance to the fluorescence-signal processing unit 57.

Next, a description will be given of a method of acquiring an image of the inner wall of the body cavity 3, used by the fluorescence endoscope 601 having the above-described structure.

Note that, since the way the outer insertion portion 613A is secured to the body cavity 3 with the balloon 615 and the way excitation light emitted by the light source 7 irradiates the body cavity 3 are the same as in the first embodiment, a description thereof will be omitted.

When the body cavity 3 is irradiated with the excitation light, the fluorescence agent on the balloon 615 is also irradiated with the excitation light. Therefore, both the body cavity 3 and the fluorescence agent generate fluorescence.

The fluorescence generated at the fluorescence agent passes through the outer insertion portion 613A and the fluorescence window 227 to enter the inner insertion portion 613B. The entering fluorescence passes through the dichroic mirror 35 to be incident on the fluorescence detecting unit 624. Based on the fluorescence intensity of the incident fluorescence, the fluorescence detecting unit 624 outputs a signal indicating the fluorescence intensity to the distance measuring unit 653.

The distance measuring unit 653 first calculates the distance from the outer circumferential face of the balloon 615 to the fluorescence detecting unit 624 based on the received signal indicating the fluorescence intensity. Then, the distance measuring unit 653 calculates the distance from the inner wall of the body cavity 3 to the image-acquisition device 43 based on the distance from the outer circumferential face of the balloon 615 to the fluorescence detecting unit 624 and calculates the above-mentioned distance signal based on the calculated distance.

Since a method of acquiring an image with the fluorescence generated at the body cavity 3 is the same as that of the second modification of the first embodiment, a description thereof will be omitted.

According to the above-described structure, the fluorescence agent disposed on the contact surface of the balloon 615 that is brought into contact with the inner wall is irradiated with the excitation light emitted outward in radial directions of the insertion portion 605. The fluorescence agent irradiated with the excitation light generates fluorescence. The fluorescence intensity of the generated fluorescence is detected by the fluorescence detecting unit 624. Since the fluorescence intensity is inversely proportional to the square of the distance from the fluorescence agent, a fluorescence-intensity signal output from the fluorescence detecting unit 624 can be regarded as a signal indicating the distance between the fluorescence agent and the fluorescence detecting unit 624.

Therefore, based on the fluorescence-intensity signal, the fluorescence-signal processing unit 57 can generate the same image signal as that generated when the distance from the inner wall to the image-acquisition device 43 of the image-acquisition unit 21 is maintained at the predetermined constant distance.

### First Modification of Second Embodiment

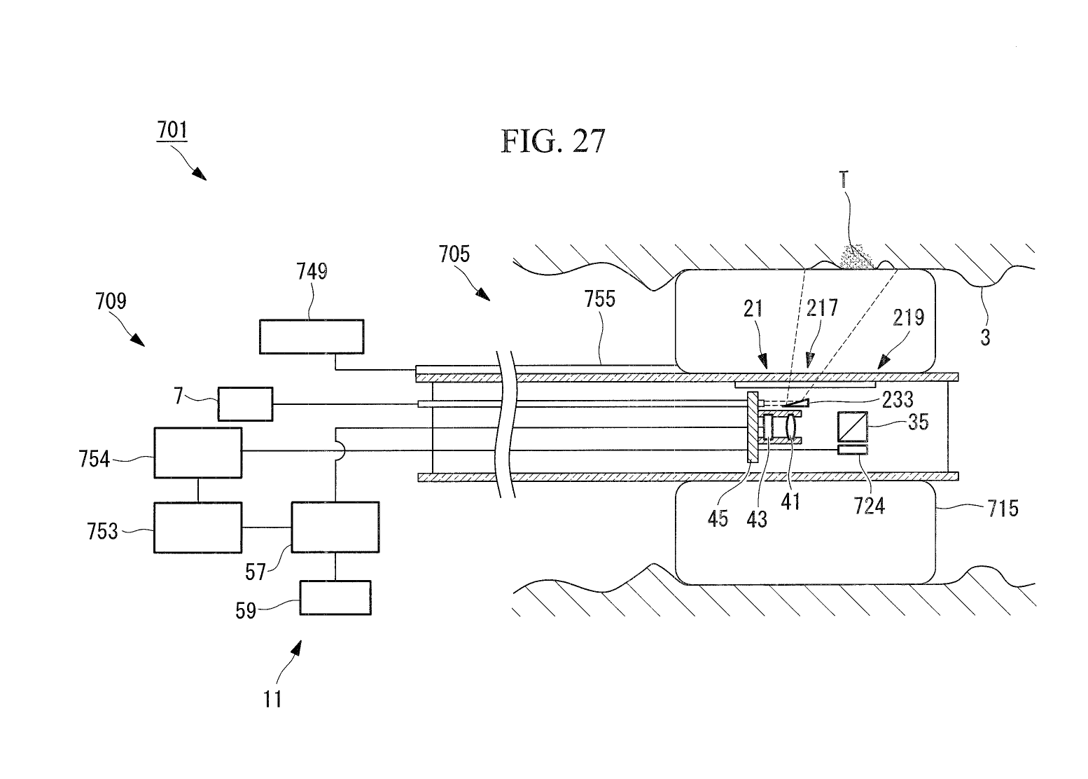

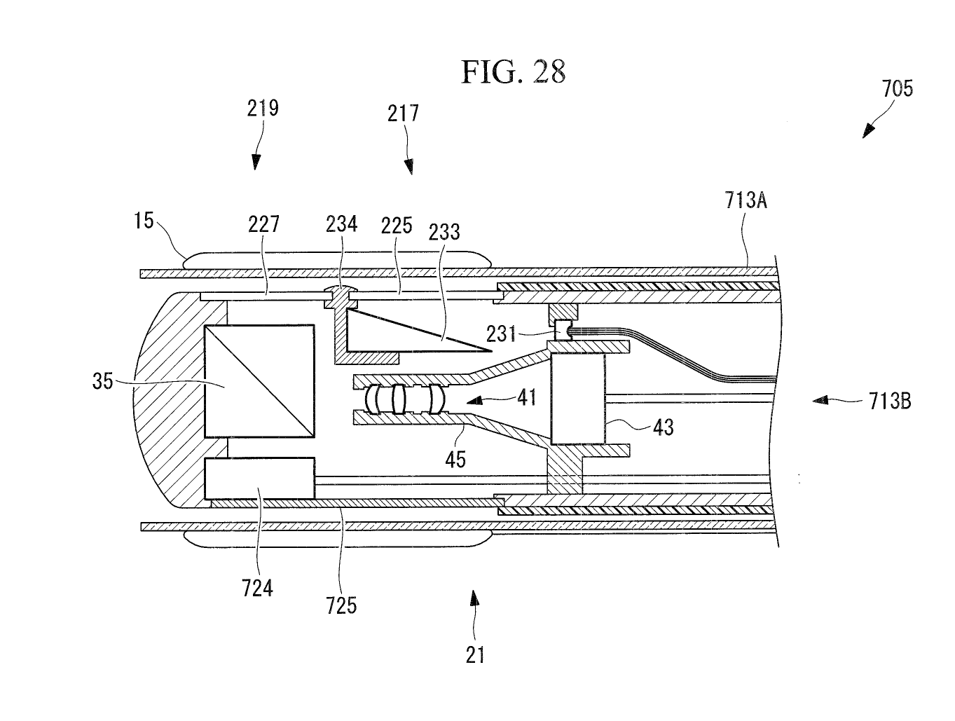

Next, a first modification of the second embodiment of the present invention will be described with reference to FIGS. 27 and 28.

Although the basic structure of a fluorescence endoscope of this modification is the same as that of the second embodiment, the structure of an insertion portion of this modification is different from that of the second embodiment. Therefore, in this modification, only the insertion portion and the components surrounding it will be described with reference to FIGS. 27 and 28, and a description of the other components will be omitted.

FIG. 27 is a view for explaining the structure of the fluorescence endoscope according to this modification.

Note that the same reference symbols are given to the same components as those of the second embodiment, and a description thereof will be omitted.

As shown in FIG. 27, a fluorescence endoscope 701 includes an insertion portion 705 that is to be inserted into the body cavity 3 of a subject, the light source 7 that emits excitation light, a measurement control unit 709 that measures the distance between the insertion portion 705 and the inner wall of the body cavity 3, and the display unit 11 that displays an acquired fluorescence image.

FIG. 28 is a view for explaining the structure of the insertion portion shown in FIG. 27.

As shown in FIG. 28, the insertion portion 705 is provided with an outer insertion portion (insertion portion) 713A and an inner insertion portion (light emitting and introducing unit, rotating unit) 713B.

The outer insertion portion 713A is a tube serving as the outer circumferential face of the insertion portion 705. The balloon 15 is disposed on the outer circumferential face of the insertion end (the left end of FIG. 28) of the outer insertion portion 713A. It is desired that at least an area of the outer insertion portion 713A where the balloon 15 is disposed and that faces the excitation-light window 225 and the fluorescence window 227, to be described later, be made from a material that transmits excitation light passing through the excitation-light window 225 and fluorescence passing through the fluorescence window 227. It is desired that the outer insertion portion 713A be made from a rigid material that transmits ultrasonic waves.

The inner insertion portion 713B is inserted into the outer insertion portion 713A. As shown in FIG. 28, the inner insertion portion 713B is provided with the excitation-light window 225, the fluorescence window 227, the light emitting part (light emitting and introducing unit) 217, the light introducing part (light emitting and introducing unit) 219, the image-acquisition unit 21, and an ultrasonic-wave generating and measuring unit (ultrasonic-signal generator, ultrasonic-signal detector) 724.

The ultrasonic-wave generating and measuring unit 724 is used to measure the distance from the inner insertion portion 713B to the contact surface of the balloon 15 that is brought into contact with the body cavity 3. The ultrasonic-wave generating and measuring unit 724 emits ultrasonic waves toward the outside of the inner insertion portion 713B and also measures ultrasonic waves propagating inside the inner insertion portion 713B. The ultrasonic-wave generating and measuring unit 724 receives from a control unit 754, to be described later, a control signal for controlling the phase of the emitted ultrasonic waves etc. and also outputs to the control unit 754 a measurement signal indicating the phase of the measured ultrasonic waves etc. The ultrasonic-wave generating and measuring unit 724 is disposed at an outer location in a radial direction of the tip of the inner insertion portion 713B. A cover 725 that serves as a part of the outer circumferential face of the inner insertion portion 713B is disposed at a location adjacent to the ultrasonic-wave generating and measuring unit 724. It is preferable that the cover 725 be made from a rigid material that transmits ultrasonic waves.

The measurement control unit 709 measures the distance between the insertion portion 705 and the inner wall of the body cavity 3. As shown in FIG. 27, the measurement control unit 709 includes a pump (inflow unit) 749, a distance measuring unit (calculation unit) 753, and the control unit 754.

The pump 749 supplies liquid (for example, water) under pressure to inflate the balloon 15. The liquid supplied under pressure by the pump 749 is sent to the balloon 15 through a conveying tube 755. Note that any known pump can be used as the pump 749; the pump 749 is not particularly limited.

The distance measuring unit 753 calculates the distance from the inner wall of the body cavity 3 to the ultrasonic-wave generating and measuring unit 724. In other words, the distance measuring unit 753 generates a distance signal indicating the distance from the inner wall of the body cavity 3 to the ultrasonic-wave generating and measuring unit 724 based on a signal indicating the phase difference, to be described later. The distance measuring unit 753 receives the signal indicating the phase difference from the control unit 754 and outputs the distance signal to the fluorescence-signal processing unit 57. Note that any known calculation method can be used as the method of calculating the distance from the inner wall of the body cavity 3 to the ultrasonic-wave generating and measuring unit 724; the distance calculation method is not particularly limited.

The control unit 754 controls the ultrasonic-wave generating and measuring unit 724 and also outputs a signal indicating the phase difference, to be described later, to the distance measuring unit 753. The control unit 754 outputs to the ultrasonic-wave generating and measuring unit 724 a control signal for controlling the emission or halting of ultrasonic waves, the phase of the emitted ultrasonic waves, etc. and receives from the ultrasonic-wave generating and measuring unit 724 a measurement signal indicating the phase of the measured ultrasonic waves etc. The control unit 754 calculates, based on the received control signal and measurement signal, the phase difference between the ultrasonic waves emitted by the ultrasonic-wave generating and measuring unit 724 and the ultrasonic waves measured by the ultrasonic-wave generating and measuring unit 724 and outputs a signal indicating the phase difference.

Next, a description will be given of a method of acquiring an image of the inner wall of the body cavity 3, used by the fluorescence endoscope 701 having the above-described structure.

Note that since a method of securing the outer insertion portion 713A to the body cavity 3 with the balloon 15 and a method of acquiring an image with fluorescence generated at the body cavity 3 are the same as those in the first embodiment, a description thereof will be omitted.

Next, a method of measuring the distance from the inner wall of the body cavity 3 to the ultrasonic-wave generating and measuring unit 724, the method being a feature of this embodiment, will be described.

In a state where the outer insertion portion 713A is secured to the body cavity 3 with the balloon 15, the control unit 754 outputs to the ultrasonic-wave generating and measuring unit 724 a control signal for emitting ultrasonic waves. When the control signal is received, the ultrasonic-wave generating and measuring unit 724_emits ultrasonic waves based on the control signal. The ultrasonic waves propagate through the cover 725, the outer insertion portion 713A, and the liquid in the balloon 15 to be reflected at the outer circumferential face of the balloon 15, which is a contact surface between the balloon 15 and the body cavity 3. The reflected ultrasonic waves propagate through the liquid in the balloon 15, the outer insertion portion 713A, and the cover 725 to be detected by the ultrasonic-wave generating and measuring unit 724. The ultrasonic-wave generating and measuring unit 724 outputs to the control unit 754 a measurement signal that includes information such as the phase of the reflected ultrasonic waves.

The control unit 754 calculates the phase difference between the ultrasonic waves emitted by the ultrasonic-wave generating and measuring unit 724 and the ultrasonic waves measured by the ultrasonic-wave generating and measuring unit 724, based on the measurement signal received from the ultrasonic-wave generating and measuring unit 724 and the control signal output to the ultrasonic-wave generating and measuring unit 724. The control unit 754 outputs a signal indicating the calculated phase difference to the distance measuring unit 753. The distance measuring unit 753 calculates the distance from the inner wall of the body cavity 3 to the ultrasonic-wave generating and measuring unit 724 based on the received signal indicating the phase difference. The distance signal indicating the calculated distance is output to the fluorescence-signal processing unit 57.

According to the above-described structure, ultrasonic waves are emitted from the ultrasonic-wave generating and measuring unit 724 toward the above-mentioned contact surface of the balloon 15 and propagate through the balloon 15 that is filled with liquid. Since the balloon 15 is filled with liquid, the attenuation rate of the ultrasonic waves is reduced compared with a case where the balloon 15 is filled with air. The ultrasonic waves propagating through the balloon 15 are reflected at the contact surface and detected by the ultrasonic-wave generating and measuring unit 724. The distance between the contact surface and the insertion portion 705 is calculated by the control unit 754 based on the phase difference between the phase of the ultrasonic waves emitted by the ultrasonic-wave generating and measuring unit 724 and the phase of the ultrasonic waves detected by the ultrasonic-wave generating and measuring unit 724.

As described above, based on the distance calculated by the control unit 754, the fluorescence-signal processing unit 57 can generate the same image signal as that generated when the distance between the inner wall and the image-acquisition unit 21 is maintained at the predetermined constant distance.

### Second Modification of Second Embodiment

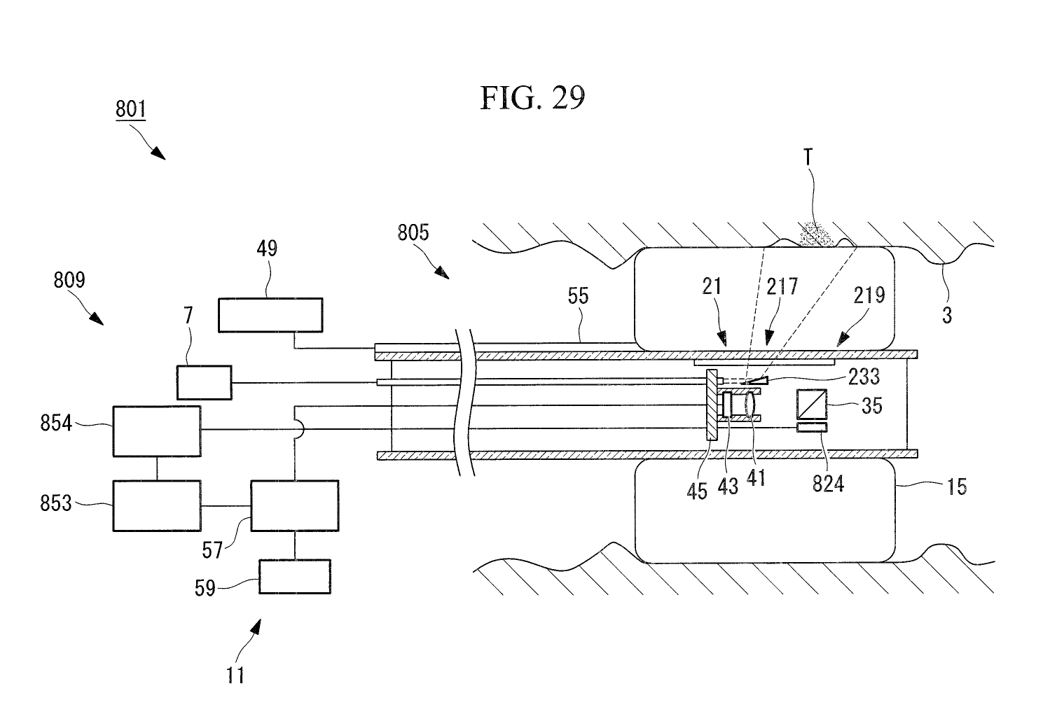

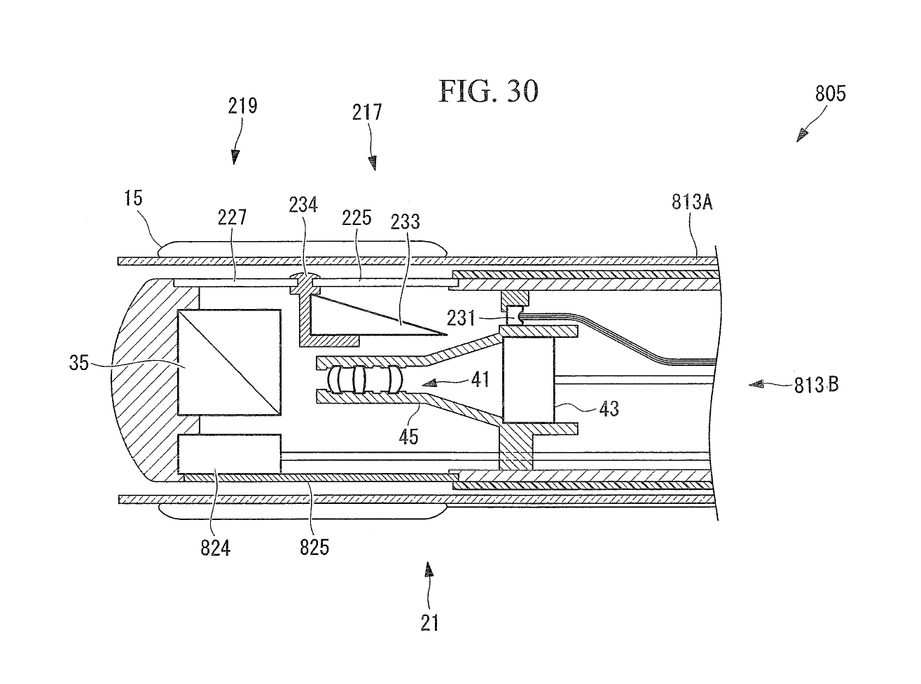

Next, a second modification of the second embodiment of the present invention will be described with reference to FIGS. 29 and 30.

Although the basic structure of a fluorescence endoscope of this modification is the same as that of the second embodiment, the structure of an insertion portion of this modification is different from that of the second embodiment. Therefore, in this modification, only the insertion portion and the components surrounding it will be described with reference to FIGS. 29 and 30, and a description of the other components will be omitted.

FIG. 29 is a view for explaining the structure of the fluorescence endoscope according to this modification.

Note that the same reference symbols are given to the same components as those of the second embodiment, and a description thereof will be omitted.

As shown in FIG. 29, a fluorescence endoscope 801 includes an insertion portion 805 that is to be inserted into the body cavity 3 of a subject, the light source 7 that emits excitation light, a measurement control unit 809 that measures the distance between the insertion portion 805 and the inner wall of the body cavity 3, and the display unit 11 that displays an acquired fluorescence image.

FIG. 30 is a view for explaining the structure of the insertion portion shown in FIG. 29.

As shown in FIG. 30, the insertion portion 805 is provided with an outer insertion portion (insertion portion) 813A and an inner insertion portion (light emitting and introducing unit, rotating unit) 813B.

The outer insertion portion 813A is a tube serving as the outer circumferential face of the insertion portion 805. The balloon 15 is disposed on the outer circumferential face of the insertion end (the left end of FIG. 30) of the outer insertion portion 813A. It is desired that at least an area of the outer insertion portion 813A where the balloon 15 is disposed and that faces the excitation-light window 225 and the fluorescence window 227, to be described later, be made from a material that transmits excitation light passing through the excitation-light window 225 and fluorescence passing through the fluorescence window 227. It is desired that the outer insertion portion 813A be made from a material that transmits microwaves.

The inner insertion portion 813B is inserted into the outer insertion portion 813A. As shown in FIG. 30, the inner insertion portion 813B is provided with the excitation-light window 225, the fluorescence window 227, the light emitting part (light emitting and introducing unit) 217, the light introducing part (light emitting and introducing unit) 219, the image-acquisition unit 21, and a microwave generating and measuring unit (microwave-signal generator, microwave-signal detector) 824.

The microwave generating and measuring unit 824 is used to measure the distance from the inner insertion portion 813B to the contact surface of the balloon 15 that is brought into contact with the body cavity 3. The microwave generating and measuring unit 824 emits microwaves toward the outside of the inner insertion portion 813B and also measures microwaves propagating inside the inner insertion portion 813B. The microwave generating and measuring unit 824 receives from a control unit 854, to be described later, a control signal for controlling the phase of the emitted microwaves etc. and also outputs to the control unit 854 a measurement signal indicating the phase of the measured ultrasonic waves etc. The microwave generating and measuring unit 824 is disposed at an outer location in a radial direction of the tip of the inner insertion portion 813B. A cover 825 that serves as a part of the outer circumferential face of the inner insertion portion 813B is disposed at a location adjacent to the microwave generating and measuring unit 824. It is preferable that the cover 825 be made from a material that transmits microwaves.

The measurement control unit 809 measures the distance between the insertion portion 805 and the inner wall of the body cavity 3. As shown in FIG. 29, the measurement control unit 809 includes the air supply pump 49, a distance measuring unit (calculation unit) 853, and the control unit 854.

The distance measuring unit 853 calculates the distance from the inner wall of the body cavity 3 to the microwave generating and measuring unit 824. In other words, the distance measuring unit 853 generates a distance signal indicating the distance from the inner wall of the body cavity 3 to the microwave generating and measuring unit 824 based on a signal indicating the phase difference, to be described later. The distance measuring unit 853 receives the signal indicating the phase difference from the control unit 854 and outputs the distance signal to the fluorescence-signal processing unit 57. Note that any known calculation method can be used as the method of calculating the distance from the inner wall of the body cavity 3 to the microwave generating and measuring unit 824; the distance calculation method is not particularly limited.

The control unit 854 controls the microwave generating and measuring unit 824 and outputs a signal indicating the phase difference, to be described later, to the distance measuring unit 853. The control unit 854 outputs to the microwave generating and measuring unit 824 a control signal for controlling the emission or halting of microwaves, the phase of the emitted microwaves, etc. and receives from the microwave generating and measuring unit 824 a measurement signal indicating the phase of the measured microwaves etc. The control unit 854 calculates, based on the received control signal and measurement signal, the phase difference between the microwaves emitted by the microwave generating and measuring unit 824 and the microwaves measured by the microwave generating and measuring unit 824 and outputs a signal indicating the phase difference.

Next, a description will be given of a method of acquiring an image of the inner wall of the body cavity 3, used by the fluorescence endoscope 801 having the above-described structure.

Note that since a method of securing the outer insertion portion 813A to the body cavity 3 with the balloon 15 and a method of acquiring an image with fluorescence generated at the body cavity 3 are the same as those in the first embodiment, a description thereof will be omitted.

Next, a method of measuring the distance from the inner wall of the body cavity 3 to the microwave generating and measuring unit 824, the method being a feature of this embodiment, will be described.

In a state where the outer insertion portion 813A is secured to the body cavity 3 with the balloon 15, the control unit 854 outputs to the microwave generating and measuring unit 824 a control signal for emitting microwaves. When the control signal is received, the microwave generating and measuring unit 824 emits microwaves based on the control signal. The microwaves propagate through the cover 825, the outer insertion portion 813A, and the balloon 15 to be reflected at the outer circumferential face of the balloon 15, which is a contact surface between the balloon 15 and the body cavity 3. The reflected microwaves propagate through the balloon 15, the outer insertion portion 813A, and the cover 825 to be detected by the microwave generating and measuring unit 824. The microwave generating and measuring unit 824 outputs to the control unit 854 a measurement signal that includes information such as the phase of the reflected microwaves.

The control unit 854 calculates the phase difference between the microwaves emitted by the microwave generating and measuring unit 824 and the microwaves measured by the microwave generating and measuring unit 824, based on the measurement signal received from the microwave generating and measuring unit 824 and the control signal output to the microwave generating and measuring unit 824. The control unit 854 outputs the signal indicating the calculated phase difference to the distance measuring unit 853. The distance measuring unit 853 calculates the distance from the inner wall of the body cavity 3 to the microwave generating and measuring unit 824 based on the received signal indicating the phase difference. A distance signal indicating the calculated distance is output to the fluorescence-signal processing unit 57.

According to the above-described structure, microwaves are emitted from the microwave generating and measuring unit 824 toward the above-mentioned contact surface of the balloon 15 and propagate through the balloon 15. The microwaves propagate through the balloon 15 at a lower attenuation rate than ultrasonic waves. The microwaves propagating through the balloon 15 are reflected at the contact surface and detected by the microwave generating and measuring unit 824.

The control unit 854 controls the microwave generating and measuring unit 824 to control the emitted microwaves and also receives a detection signal output from the microwave generating and measuring unit 824. Therefore, the control unit 854 can calculate the distance between the above-mentioned contact surface and the insertion portion 805 based on the phase difference between the phase of the microwaves emitted by the microwave generating and measuring unit 824 and the phase of the microwaves detected by the microwave generating and measuring unit 824.

As described above, based on the distance calculated by the control unit 854, the fluorescence-signal processing unit 57 can generate the same image signal as that generated when the distance from the inner wall to the image-acquisition device 43 of the image-acquisition unit 21 is maintained at the predetermined constant distance.

Note that the technical scope of the present invention is not limited to the above-described embodiments, and various modifications can be made without departing from the scope of the present invention.

For example, in the first modification of the first embodiment, in order to calculate the distance between the inner wall of the body cavity and the insertion portion, it is possible to provide an ultrasonic-wave generating and measuring unit at the tip of a measurement insertion portion instead of the section for measuring the flow of the balloon.

1. A fluorescence endoscope comprising:
an insertion portion that is to be inserted into a body cavity;
a balloon that is brought into contact with an inner wall of the body cavity located in radial directions of the insertion portion, thereby positioning the insertion portion with respect to the body cavity in the radial directions of the insertion portion;
a light emitting and introducing unit that emits excitation light for irradiating the inner wall, outward in the radial directions of the insertion portion, and that introduces fluorescence generated at the inner wall to the inside of the insertion portion from a plurality of different radial directions of the insertion portion;
an image-acquisition unit that acquires an image with the fluorescence introduced by the light emitting and introducing unit;
a correction-signal calculating unit that calculates a correction signal for correcting an image-acquisition signal output from the image-acquisition unit, based on a distance between the insertion portion and a contact surface of the balloon that is brought into contact with the inner wall; and
a signal processing unit that corrects the intensity of the image-acquisition signal based on the correction signal and generates an image signal from the corrected image-acquisition signal.

2. A fluorescence endoscope according to claim 1, wherein:
the light emitting and introducing unit comprises:
an irradiation unit that emits the excitation light outward in the radial directions of the insertion portion; and
a reflecting unit that reflects the fluorescence generated at the inner wall in the direction of the central axis of the insertion portion and that is disposed so as to be rotatable about the central axis; and
the image-acquisition unit acquires the image with the fluorescence reflected by the reflecting unit.

3. A fluorescence endoscope according to claim 2, further comprising a rotary drive unit that rotates the reflecting unit.

4. A fluorescence endoscope according to claim 1, wherein:
the light emitting and introducing unit comprises:
a rotating unit that is disposed inside at least the tip of the insertion portion so as to be rotatable about the central axis of the insertion portion;
an irradiation unit that is provided in the rotating unit and that emits the excitation light outward in radial directions of the insertion portion; and
a reflecting unit that is provided in the rotating unit and that reflects the fluorescence generated at the inner wall in the direction of the central axis; and
the image-acquisition unit is provided in the rotating unit and acquires the image with the fluorescence reflected by the reflecting unit.

5. A fluorescence endoscope according to claim 1, wherein:
the light emitting and introducing unit comprises:
a rotating unit that is disposed inside at least the tip of the insertion portion so as to be rotatable about the central axis of the insertion portion; and
an irradiation unit that is provided in the rotating unit and that emits the excitation light outward in radial directions of the insertion portion; and
the image-acquisition unit acquires the image with fluorescence introduced to the inside of the rotating unit.

6. A fluorescence endoscope according to claim 1, wherein:
the light emitting and introducing unit comprises:
an irradiation unit that emits the excitation light outward in the radial directions of the insertion portion; and
a conical mirror that reflects the fluorescence generated at the inner wall in the direction of the central axis of the insertion portion; and
the image-acquisition unit acquires the image with the fluorescence reflected by the conical mirror.

7. A fluorescence endoscope according to claim 1, further comprising:
an insertion-length measurement unit that measures an insertion length of the insertion portion with respect to the body cavity; and
an image processing unit that applies unrolling processing to the image-acquisition signal based on the image-acquisition signal output from the image-acquisition unit and a signal indicating the insertion length output from the insertion-length measurement unit.

8. A fluorescence endoscope according to claim 1, further comprising:
an inflow unit that supplies fluid to the balloon;
a flow measurement unit that measures the flow of the fluid supplied to the balloon; and
a calculation unit that calculates the distance between the insertion portion and the contact surface of the balloon that is brought into contact with the inner wall, based on a flow signal output from the flow measurement unit,
wherein the correction-signal calculating unit calculates the correction signal based on the distance calculated by the calculation unit.

9. A fluorescence endoscope according to claim 1, wherein:
a fluorescence agent is disposed on the contact surface of the balloon that is brought into contact with the inner wall;
a fluorescence detecting unit that detects the intensity of fluorescence generated at the fluorescence agent is provided; and
the correction-signal calculating unit calculates the correction signal based on the distance calculated by the calculation unit.

10. A fluorescence endoscope according to claim 1, wherein:
the fluid supplied to the balloon is liquid;
an ultrasonic-signal generator that emits ultrasonic waves toward the contact surface of the balloon that is brought into contact with the inner wall is provided;
an ultrasonic-signal detector that detects ultrasonic waves reflected by the contact surface is provided;
a control unit that controls the ultrasonic-signal generator and also calculates the distance between the insertion portion and the contact surface of the balloon that is brought into contact with the inner wall, based on a detection signal output from the ultrasonic-signal detector, is provided; and
the correction-signal calculating unit calculates the correction signal based on the distance calculated by the control unit.

11. A fluorescence endoscope according to claim 1, further comprising:
a microwave-signal generator that emits microwaves toward the contact surface of the balloon that is brought into contact with the inner wall;
a microwave-signal detector that detects microwaves reflected by the contact surface; and
a control unit that controls the microwave-signal generator and also calculates the distance between the insertion portion and the contact surface of the balloon that is brought into contact with the inner wall, based on a detection signal output from the microwave-signal detector,
wherein the correction-signal calculating unit calculates the correction signal based on the distance calculated by the control unit.
